(19) United States
(12) Patent Application Publication
(10) Pub. No.: US 2026/0223117 A1
(43) Pub. Date: Jul. 30, 2026

(54) SKIPPING INDICATIONS FOR UPLINK CONFIGURED GRANTS

(71) Applicant: QUALCOMM Incorporated, San Diego, CA (US)

(72) Inventors: Fang YUAN, Beijing (CN); Iyab Issam SAKHNINI, San Diego, CA (US); Wanshi CHEN, San Diego, CA (US); Yan ZHOU, San Diego, CA (US); Tao LUO, San Diego, CA (US)

(21) Appl. No.: 19/144,804

(22) PCT Filed: Feb. 22, 2023
(86) PCT No.: PCT/CN2023/077583

§ 371 Date: Jun. 30, 2025

(51) Int. Cl. H04W 72/21

(52) U.S. Cl. CPC H04W 72/21

(57) ABSTRACT

Methods, systems, and devices for wireless communication are described. A user equipment (UE) may receive multiple indications of multiple uplink resource allocations on one or more component carriers from a network entity. The multiple uplink resource allocations may be associated with multiple configured grants that schedule multiple uplink transmission occasions for the UE across the multiple uplink resource allocations. The UE may transmit uplink control information (UCI) to the network entity that indicates a set of uplink transmission occasions during which the UE skips uplink transmissions. The UE may transmit an uplink message to the network entity in accordance with the multiple configured grants and the UCI.

### CROSS REFERENCE

The present Application is a 371 national phase filing of International PCT Application No. PCT/CN2023/077583 by YUAN et al., entitled “SKIPPING INDICATIONS FOR UPLINK CONFIGURED GRANTS,” filed Feb. 22, 2023, which is assigned to the assignee hereof, and which is expressly incorporated by reference in its entirety herein.

### FIELD OF TECHNOLOGY

The following relates to wireless communication, including skipping indications for uplink configured grants.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). In some communications systems, these communication devices may support software applications that generate periodic data traffic. In some cases, a communication device may use an uplink configured grant to transmit periodic data traffic to a network entity.

### SUMMARY

The described techniques relate to improved methods, systems, devices, and apparatuses that support skipping indications for uplink configured grants. For example, the described techniques provide a framework for indicating configured grant transmission occasions during which a user equipment (UE) may skip uplink transmissions. In some examples, the UE may receive indications of uplink resource allocations on one or more component carriers from a network entity. In such examples, the uplink resource allocations may be associated with multiple configured grants that schedule uplink transmission occasions for the UE across the uplink resource allocations. The UE may transmit uplink control information (UCI) to the network entity that indicates a set of uplink transmission occasions during which the UE skips uplink transmissions. In some examples, the UE may transmit an uplink message to the network entity in accordance with the multiple configured grants and the UCI.

A method for wireless communication at a UE is described. The method may include receiving, from a network entity, a set of multiple indications of a set of multiple uplink resource allocations, where the set of multiple uplink resource allocations are associated with a set of multiple configured grants that schedule a set of multiple uplink transmission occasions for the UE across the set of multiple uplink resource allocations on one or more component carriers, transmitting, to the network entity, UCI that indicates a set of uplink transmission occasions from the set of multiple uplink transmission occasions during which the UE skips uplink transmissions, and transmitting, to the network entity, an uplink message in accordance with the set of multiple configured grants and the UCI.

An apparatus for wireless communication at a UE is described. The apparatus may include a processor, memory coupled with the processor, and instructions stored in the memory. The instructions may be executable by the processor to cause the apparatus to receive, from a network entity, a set of multiple indications of a set of multiple uplink resource allocations, where the set of multiple uplink resource allocations are associated with a set of multiple configured grants that schedule a set of multiple uplink transmission occasions for the UE across the set of multiple uplink resource allocations on one or more component carriers, transmit, to the network entity, UCI that indicates a set of uplink transmission occasions from the set of multiple uplink transmission occasions during which the UE skips uplink transmissions, and transmit, to the network entity, an uplink message in accordance with the set of multiple configured grants and the UCI.

Another apparatus for wireless communication at a UE is described. The apparatus may include means for receiving, from a network entity, a set of multiple indications of a set of multiple uplink resource allocations, where the set of multiple uplink resource allocations are associated with a set of multiple configured grants that schedule a set of multiple uplink transmission occasions for the UE across the set of multiple uplink resource allocations on one or more component carriers, means for transmitting, to the network entity, UCI that indicates a set of uplink transmission occasions from the set of multiple uplink transmission occasions during which the UE skips uplink transmissions, and means for transmitting, to the network entity, an uplink message in accordance with the set of multiple configured grants and the UCI.

A non-transitory computer-readable medium storing code for wireless communication at a UE is described. The code may include instructions executable by a processor to receive, from a network entity, a set of multiple indications of a set of multiple uplink resource allocations, where the set of multiple uplink resource allocations are associated with a set of multiple configured grants that schedule a set of multiple uplink transmission occasions for the UE across the set of multiple uplink resource allocations on one or more component carriers, transmit, to the network entity, UCI that indicates a set of uplink transmission occasions from the set of multiple uplink transmission occasions during which the UE skips uplink transmissions, and transmit, to the network entity, an uplink message in accordance with the set of multiple configured grants and the UCI.

In some examples of the method, apparatuses, and non-transitory computer-readable medium described herein, transmitting the UCI may include operations, features, means, or instructions for transmitting the UCI during an uplink transmission occasion of the set of multiple uplink transmission occasions and on a component carrier of the one or more component carriers, where the uplink transmission occasion may be scheduled via a configured grant of the set of multiple configured grants, and where the set of uplink transmission occasions occur subsequent to the uplink transmission occasion.

In some examples of the method, apparatuses, and non-transitory computer-readable medium described herein, the set of uplink transmission occasions includes one or more uplink transmission occasions that may be scheduled via the configured grant.

In some examples of the method, apparatuses, and non-transitory computer-readable medium described herein, the set of uplink transmission occasions includes one or more uplink transmission occasions on the component carrier.

In some examples of the method, apparatuses, and non-transitory computer-readable medium described herein, the set of uplink transmission occasions includes a first one or more uplink transmission occasions that may be scheduled via the configured grant and a second one or more other uplink transmission occasions that may be scheduled via a second configured grant of the set of multiple configured grants and the configured grant and the second configured grant may be associated with different component carriers.

Some examples of the method, apparatuses, and non-transitory computer-readable medium described herein may further include operations, features, means, or instructions for transmitting the UCI during the uplink transmission occasion scheduled via the configured grant indicates that the set of uplink transmission occasions may be associated with at least the configured grant.

Some examples of the method, apparatuses, and non-transitory computer-readable medium described herein may further include operations, features, means, or instructions for transmitting the UCI on the component carrier indicates that the set of uplink transmission occasions may be associated with at least the component carrier.

In some examples of the method, apparatuses, and non-transitory computer-readable medium described herein, the UCI includes at least one configured grant identifier that indicates at least one configured grant of the set of multiple configured grants that may be associated with the set of uplink transmission occasions.

In some examples of the method, apparatuses, and non-transitory computer-readable medium described herein, the UCI includes at least one component carrier index that indicates at least one component carrier of the one or more component carriers that may be associated with the set of uplink transmission occasions.

In some examples of the method, apparatuses, and non-transitory computer-readable medium described herein, the UCI indicates a duration during which the UE skips uplink transmissions, the set of uplink transmission occasions occur during the duration and, and the duration may be associated with a timing offset.

In some examples of the method, apparatuses, and non-transitory computer-readable medium described herein, the UCI indicates the timing offset associated with the duration.

Some examples of the method, apparatuses, and non-transitory computer-readable medium described herein may further include operations, features, means, or instructions for receiving, from the network entity, an indication of the timing offset associated with the duration.

In some examples of the method, apparatuses, and non-transitory computer-readable medium described herein, the duration includes a quantity of slots or symbols, a quantity of uplink transmission occasions, a quantity of time units, or any combination thereof.

In some examples of the method, apparatuses, and non-transitory computer-readable medium described herein, the timing offset includes a quantity of consecutive slots or symbols, a quantity of consecutive uplink transmission occasions, a quantity of time units, or any combination thereof.

In some examples of the method, apparatuses, and non-transitory computer-readable medium described herein, the duration includes a quantity of time periods and a time period may be based on a periodicity associated with a configured grant of the set of multiple configured grants that was used to schedule a respective uplink transmission occasion of the set of uplink transmission occasions.

In some examples of the method, apparatuses, and non-transitory computer-readable medium described herein, the timing offset includes a quantity of time periods and a time period may be based on a periodicity associated with a configured grant of the set of multiple configured grants that was used to schedule a respective uplink transmission occasion of the set of uplink transmission occasions.

In some examples of the method, apparatuses, and non-transitory computer-readable medium described herein, the UCI includes a bitmap that indicates a set of multiple durations during which the UE skips uplink transmissions and the set of uplink transmission occasions occur across the set of multiple durations.

Some examples of the method, apparatuses, and non-transitory computer-readable medium described herein may further include operations, features, means, or instructions for receiving, from the network entity, an indication of a quantity of bits associated with the bitmap, where a temporal length associated with each duration of the set of multiple durations may be based on the quantity of bits.

In some examples of the method, apparatuses, and non-transitory computer-readable medium described herein, the set of uplink transmission occasions occur during a duration associated with a default subcarrier spacing.

In some examples of the method, apparatuses, and non-transitory computer-readable medium described herein, the set of uplink transmission occasions occur during a duration associated with a subcarrier spacing that may be based on a component carrier used for transmission of the UCI.

In some examples of the method, apparatuses, and non-transitory computer-readable medium described herein, an uplink transmission occasion of the set of uplink transmission occasions correspond to two uplink transmission occasions that may be overlapping in time.

In some examples of the method, apparatuses, and non-transitory computer-readable medium described herein, two or more uplink transmission occasion of the set of uplink transmission occasions may be overlapping in time.

A method for wireless communication at a network entity is described. The method may include outputting a set of multiple indications of a set of multiple uplink resource allocations, where the set of multiple uplink resource allocations are associated with a set of multiple configured grants that schedule a set of multiple uplink transmission occasions for a UE across the set of multiple uplink resource allocations on one or more component carriers, obtaining UCI that indicates a set of uplink transmission occasions from the set of multiple uplink transmission occasions during which the UE skips uplink transmissions, and obtaining an uplink message in accordance with the set of multiple configured grants and the UCI.

An apparatus for wireless communication at a network entity is described. The apparatus may include a processor, memory coupled with the processor, and instructions stored in the memory. The instructions may be executable by the processor to cause the apparatus to output a set of multiple indications of a set of multiple uplink resource allocations, where the set of multiple uplink resource allocations are associated with a set of multiple configured grants that schedule a set of multiple uplink transmission occasions for a UE across the set of multiple uplink resource allocations on one or more component carriers, obtain UCI that indicates a set of uplink transmission occasions from the set of multiple uplink transmission occasions during which the UE skips uplink transmissions, and obtain an uplink message in accordance with the set of multiple configured grants and the UCI.

Another apparatus for wireless communication at a network entity is described. The apparatus may include means for outputting a set of multiple indications of a set of multiple uplink resource allocations, where the set of multiple uplink resource allocations are associated with a set of multiple configured grants that schedule a set of multiple uplink transmission occasions for a UE across the set of multiple uplink resource allocations on one or more component carriers, means for obtaining UCI that indicates a set of uplink transmission occasions from the set of multiple uplink transmission occasions during which the UE skips uplink transmissions, and means for obtaining an uplink message in accordance with the set of multiple configured grants and the UCI.

A non-transitory computer-readable medium storing code for wireless communication at a network entity is described. The code may include instructions executable by a processor to output a set of multiple indications of a set of multiple uplink resource allocations, where the set of multiple uplink resource allocations are associated with a set of multiple configured grants that schedule a set of multiple uplink transmission occasions for a UE across the set of multiple uplink resource allocations on one or more component carriers, obtain UCI that indicates a set of uplink transmission occasions from the set of multiple uplink transmission occasions during which the UE skips uplink transmissions, and obtain an uplink message in accordance with the set of multiple configured grants and the UCI.

In some examples of the method, apparatuses, and non-transitory computer-readable medium described herein, transmitting the UCI may include operations, features, means, or instructions for obtaining the UCI during an uplink transmission occasion of the set of multiple uplink transmission occasions and on a component carrier of the one or more component carriers, where the uplink transmission occasion may be scheduled via a configured grant of the set of multiple configured grants, and where the set of uplink transmission occasions occur subsequent to the uplink transmission occasion.

In some examples of the method, apparatuses, and non-transitory computer-readable medium described herein, the UCI includes at least one configured grant identifier that indicates at least one configured grant of the set of multiple configured grants that may be associated with the set of uplink transmission occasions and indicates at least one component carrier index that indicates at least one component carrier of the one or more component carriers that may be associated with the set of uplink transmission occasions.

In some examples of the method, apparatuses, and non-transitory computer-readable medium described herein, the UCI indicates a duration during which the UE skips uplink transmissions, the set of uplink transmission occasions occur during the duration and, and the duration may be associated with a timing offset.

In some examples of the method, apparatuses, and non-transitory computer-readable medium described herein, the UCI includes a bitmap that indicates a set of multiple durations during which the UE skips uplink transmissions and the set of uplink transmission occasions occur across the set of multiple durations.

Some examples of the method, apparatuses, and non-transitory computer-readable medium described herein may further include operations, features, means, or instructions for receiving, from the network entity, an indication of a quantity of bits associated with the bitmap, where a temporal length associated with each duration of the set of multiple durations may be based on the quantity of bits.

### BRIEF DESCRIPTION OF THE DRAWINGS

FIGS. 1 and 2 each illustrate an example of a wireless communications system that supports skipping indications for uplink configured grants in accordance with one or more aspects of the present disclosure.

FIGS. 3A and 3B each illustrate an example of a configured grant diagram that supports skipping indications for uplink configured grants in accordance with one or more aspects of the present disclosure.

FIGS. 4A, 4B, 4C, 5A, 5B, 5C, 6A, and 6B illustrates an example of a skipping indication scheme that supports skipping indications for uplink configured grants in accordance with one or more aspects of the present disclosure.

FIG. 7 illustrates an example of a component carrier diagram that supports skipping indications for uplink configured grants in accordance with one or more aspects of the present disclosure.

FIG. 8 illustrates an example of a process flow that supports skipping indications for uplink configured grants in accordance with one or more aspects of the present disclosure.

FIGS. 9 and 10 illustrate block diagrams of devices that support skipping indications for uplink configured grants in accordance with one or more aspects of the present disclosure.

FIG. 11 illustrates a block diagram of a communications manager that supports skipping indications for uplink configured grants in accordance with one or more aspects of the present disclosure.

FIG. 12 illustrates a diagram of a system including a device that supports skipping indications for uplink configured grants in accordance with one or more aspects of the present disclosure.

FIGS. 13 and 14 illustrate block diagrams of devices that support skipping indications for uplink configured grants in accordance with one or more aspects of the present disclosure.

FIG. 15 illustrates a block diagram of a communications manager that supports skipping indications for uplink configured grants in accordance with one or more aspects of the present disclosure.

FIG. 16 illustrates a diagram of a system including a device that supports skipping indications for uplink configured grants in accordance with one or more aspects of the present disclosure.

FIGS. 17 through 20 illustrate flowcharts showing methods that support skipping indications for uplink configured grants in accordance with one or more aspects of the present disclosure.

### DETAILED DESCRIPTION

In some wireless communication systems, a communication device (e.g., a user equipment (UE), a network entity) may support one or more types of software application that generate various types of data traffic. For example, the UE may support one or more software applications that generate periodic data traffic, such as an extended reality (XR) application. In such examples, the UE may use one or more uplink configured grants to transmit periodic data traffic, such as may be generated in accordance with the XR application, to the network entity. For example, the network entity may configure the UE with uplink configured grants that schedule uplink transmission occasions for the UE across resource allocations. That is, the UE may be configured with a resource allocation on a component carrier and an uplink configured grant may schedule multiple uplink transmission occasions for the UE across the resource allocation. The UE may use the scheduled uplink transmission occasions to transmit periodic data traffic (e.g., in an absence of receiving another uplink grant) to the network entity. In some examples, however, the UE may lack periodic data traffic to transmit to the network entity during a scheduled uplink transmission occasions. In such examples, the scheduled uplink transmission occasions may be unused by the UE, which may reduce resource utilization and capacity within the wireless communications system.

Various aspects of the present disclosure generally relate to techniques that support skipping indications for uplink configured grants and, more specifically, to a framework for indicating configured grant transmission occasions during which a UE may skip uplink transmissions. For example, a network entity may configure the UE with multiple uplink resource allocations on one or more component carriers. The uplink resource allocations may be associated with multiple configured grants that schedule multiple uplink transmission occasions for the UE across the uplink resource allocations. The UE may transmit a skipping indication to the network entity that indicates a set of uplink transmission occasions from the multiple uplink transmission occasions scheduled for the UE. The set of uplink transmission occasions may include one or more scheduled uplink transmission occasions during which the UE may skip uplink transmissions. The UE may transmit the skipping indication via uplink control signaling, such as via a medium access control control element (MAC-CE) or uplink control information (UCI). The skipping indication may apply to one or multiple configured grants, one or multiple component carriers, or any combination thereof. That is, the set of uplink transmission occasions may include multiple uplink transmission occasions scheduled via multiple configured grants that may be associated with one or multiple component carriers. The skipping indication may implicitly indicate the set of uplink transmission occasions by indicating a duration during which the UE may skip uplink transmissions. Additionally, or alternatively, the skipping indication may indicate the set of uplink transmission occasions explicitly, such as via a bitmap. In some examples, the UE may communicate with the network entity in accordance with the skipping indication.

Aspects of the subject matter described herein may be implemented to realize one or more of the following potential advantages. For example, techniques for transmitting skipping indications for uplink configured grants, as described herein, may be employed by the described communication devices to provide benefits and enhancements to the operation of the communication devices, including enabling a network entity to reallocate resources that may be otherwise unused by a UE to one or more other UEs. Further, such techniques may support increased capacity and improved resource utilization, among other possible benefits. Aspects of the disclosure are initially described in the context of wireless communications systems. Aspects of the disclosure are also described in the context of configured grant diagrams, skipping indication schemes, a component carrier diagram, and a process flow. Aspects of the disclosure are further illustrated by and described with reference to apparatus diagrams, system diagrams, and flowcharts that relate to skipping indications for uplink configured grants.

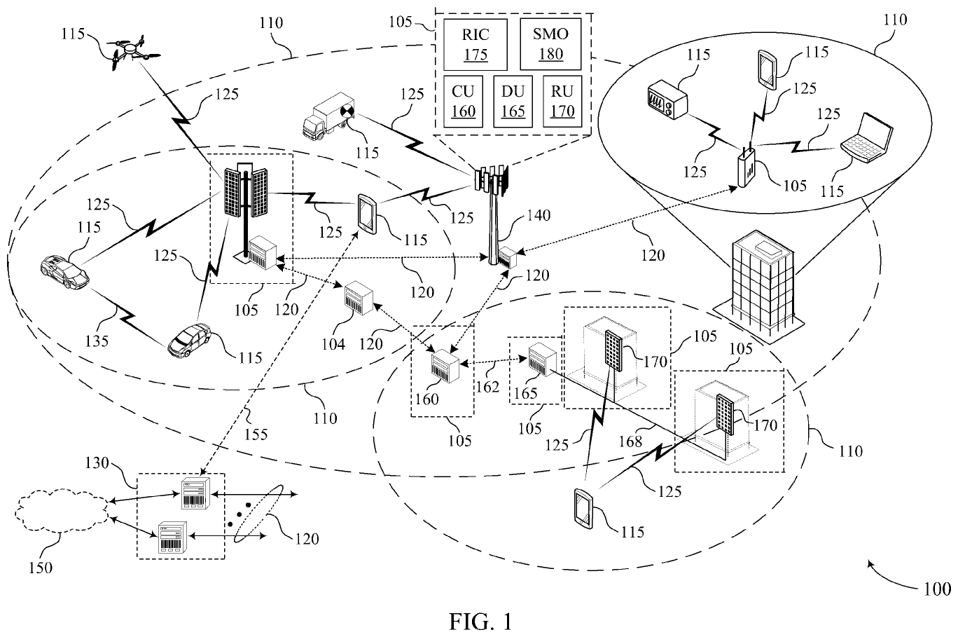

FIG. 1 illustrates an example of a wireless communications system 100 that supports skipping indications for uplink configured grants in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support skipping indications for uplink configured grants as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples of the wireless communication system 100, a UE 115 and a network entity 105 may support one or more types of software application that generate periodic data traffic. For example, the UE 115 may support an XR application (or some other type of gaming application) that generates periodic data traffic. The UE 115 may use an uplink configured grants to transmit periodic traffic generated in accordance with the XR application. In some examples, however, the UE 115 may lack periodic data traffic to transmit during one or more uplink transmission occasions scheduled for the UE 115 via the uplink configured grant. In such examples, the one or more of the uplink transmission occasions may be unused by the UE 115, which may lead to reduced resource utilization and capacity within the wireless communications system 100.

In some examples, the UE 115 may support a framework for indicating configured grant transmission occasions during which the UE 115 may skip uplink transmissions. For example, the UE 115 may receive multiple indications of uplink resource allocations on one or more component carriers from the network entity 105. The uplink resource allocations may be associated with multiple configured grants that schedule multiple uplink transmission occasions for the UE 115 across the uplink resource allocations. The UE 115 may transmit a skipping indication to the network entity that indicates the one or more uplink transmission occasions during which the UE 115 may skip uplink transmissions. In some examples, by indicating configured grant transmission occasions during which the UE 115 may skip uplink transmissions, the network entity 105 may reallocate resources that may be otherwise unused by the UE 115 to one or more other UEs 115. Reallocating resources that may be otherwise unused may lead to increased capacity within the wireless communications system 100, among other possible benefits.

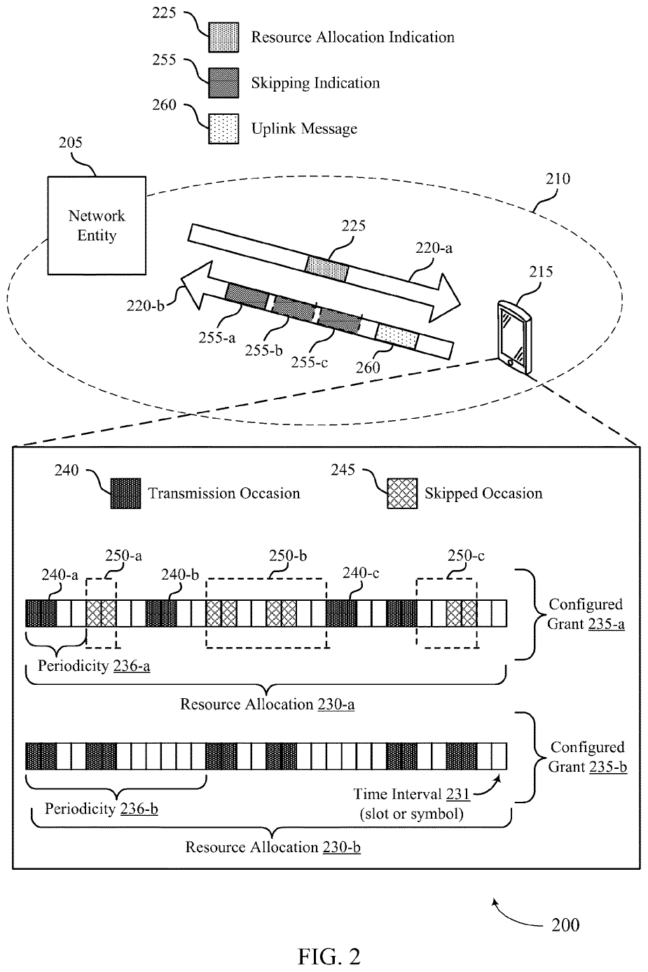

FIG. 2 illustrates an example of a wireless communications system 200 that supports skipping indications for uplink configured grants in accordance with one or more aspects of the present disclosure. The wireless communications system 200 may implement or be implemented to realize or facilitate aspects of the wireless communications system 100. For example, the wireless communications system 200 may include a UE 215 and a network entity 205, which may be examples of the corresponding devices illustrated by and described with reference to FIG. 1. In the example of FIG. 2, the network entity 205 and the UE 215 may communicate within a coverage area 210, which may be an example of a coverage area 110 illustrated by and described with reference to FIG. 1. The network entity 205 and the UE 215 may communicate within the coverage area 210 via a communication link 220-a and a communication link 220-b, which may be examples of a communication link 125 (e.g., a Uu interface) illustrated by and described with reference to FIG. 1. For example, the communication link 220-a may be an example of a downlink communication link and a communication link 220-b may be an example of an uplink communication link.

The network entity 205 and the UE 215 may support one or more types of software application that generate data traffic. The generated data traffic may be communicated between the UE 215 and the network entity 205. In some examples, software applications supported at the UE 215 and the network entity 205 may generate different types of data traffic. For example, some software applications may generate periodic data traffic, while some other software applications may generate aperiodic data traffic. In some examples, periodic data traffic may be referred to as real-time-traffic and aperiodic traffic may be referred to as non-real-time-traffic. In some examples, the UE 215 and the network entity 205 may support one or more extended reality (XR) applications. Data traffic generated in accordance with an XR application (e.g., XR traffic) may be periodic. In some examples, XR traffic may be associated with one or more characteristics (e.g., XR traffic characteristics). For example, a quantity and size of data packets transmitted in accordance with an XR application may vary. That is, a characteristic of XR traffic may include variability in a quantity and size of data packets (e.g., per burst). In some examples, a periodicity associated with XR traffic may include non-integer values. That is, a characteristic of XR traffic may include non-integer periods, such as about a 16.67 ms period (e.g., about 1/60 frames per second (fps)) or about an 8.33 ms period (e.g., about 1/120 fps). In some examples, an XR application may be associated with jitter. That is, a characteristic of XR traffic may include variable arrival times, which may lead to jitter. For example, arrival times of XR traffic generated by some XR applications may vary and cause jitter within around ±4 ms. In some examples, XR traffic may be associated with multiple data traffic flows. That is, a characteristic of XR traffic may include multiple traffic flows. For some XR applications, multiple flows may be configured with multiple (e.g., different) configurations. In some examples, a packet delay budget (PDB) associated with some XR applications may be constrained. That is, a characteristic of XR traffic may include constrained PDBs, which may impact a latency associated with communicating data traffic in accordance with the XR applications.

In some examples, to improve communication of XR traffic, the wireless communications system 200 may support XR-awareness at a RAN (e.g., RAN2). That is, the network entity 205 may support one or more mechanisms for XR-awareness, in which the network entity 205 (or the UE 215) may identify XR traffic characteristics (e.g., both uplink XR traffic and downlink XR traffic characteristics), such as QoS metrics and application layer attributes that may be relatively beneficial for the network entity 205 (e.g., a gNB) to be aware of. For example, the network entity 205 may use identified XR traffic characteristics (or other information associated with XR traffic) to aid XR-specific traffic handling (e.g., at the network entity 205).

In some examples of XR-specific traffic handling, the network entity 205 (e.g., the RAN, such as RAN1 or RAN2) may support one or more techniques for XR-specific power saving. For example, the network entity 205 may support XR-specific power saving techniques to accommodate XR service characteristics (e.g., periodicity, multiple flows, jitter, latency, reliability). In some examples, such techniques may include (or be otherwise associated with) one or more connected mode discontinuous reception (C-DRX) enhancements, or one or more physical downlink control channel (PDCCH) monitoring enhancements, or both. Additionally, or alternatively, the network entity 205 may support one or more techniques for XR-specific capacity improvements. For example, the network entity 205 may support one or more mechanisms that may provide more efficient resource allocation and scheduling for XR service characteristics (e.g., periodicity, multiple flows, jitter, latency, reliability), among other possible benefits. In some examples, such mechanisms may include (or be otherwise associated with) semi-persistent scheduling (SPS) and configured grant enhancements (e.g., uplink configured grant enhancements). Additionally, or alternatively, such mechanisms may include (or be otherwise associated with) dynamic scheduling, or dynamic grant enhancements, or both.

For example, the UE 215 may use uplink configured grants to transmit periodic traffic generated in accordance with one or more XR applications. For example, the network entity 205 may indicate one or more uplink configured grant configurations to the UE 215. In some examples, the network entity 205 may transmit control signaling (e.g., RRC signaling) to the UE 215 that indicates one or more resource allocations for a physical uplink shared channel (PUSCH), which may be associated with one or more configured grants. As illustrated in the example of FIG. 2, the network entity 205 may transmit a resource allocation indication 225 to the UE 215, which may indicate a resource allocation 230-a and a resource allocation 230-b to the UE 215. For example, the resource allocation indication 225 may include one or more information elements (IEs), such as one or more configuredGrantConfig IEs, that indicate the resource allocation 230-a and the resource allocation 230-b. In some examples, the one or more IEs may include respective resource allocation fields, respective timeDomainAllocation fields, or respective frequency DomainAllocation fields, among other examples, that may indicate the resource allocation 230-a and the resource allocation 230-b. The resource allocation 230-a and the resource allocation 230-b may be associated with a single (e.g., same) component carrier or multiple (e.g., different) component carriers. That is, the resource allocation 230-a may include multiple time intervals 231 (e.g., slots or symbols) on a first component carrier and the resource allocation 230-b may include multiple time intervals 231 on the first component carrier or a second component carrier different from the first component carrier. Additionally, the resource allocation 230-a and the resource allocation 230-b may be associated with multiple (e.g., different) configured grants. For example, the resource allocation 230-a may be associated with a configured grant 235-a and the resource allocation 230-b may be associated with a configured grant 235-b. That is, the UE 215 may receive one or more indications of multiple resource allocations (e.g., the resource allocation 230-a and the resource allocation 230-b) in which the multiple resource allocations may be associated with multiple configured grants (e.g., the configured grant 235-a and the configured grant 235-b) that schedule multiple uplink transmission occasions (e.g., transmission occasions 240) for the UE 215 across the multiple resource allocations on one or more component carriers.

In some examples, the resource allocation indication 225 may include one or more indications of a configured grant identifier (CG-ID). For example, the resource allocation indication 225 may include an indication of a first CG-ID (CG-ID1) that indicates the configured grant 235-a and an indication of a second CG-ID identifier (CG-ID2) that indicates the configured grant 235-b. The configured grant 235-a may schedule one or more of the transmission occasions 240 for the UE 215 across the resource allocation 230-a. Additionally, the configured grant 235-b may schedule one or more of the transmission occasions 240 for the UE 215 across the resource allocation 230-b. As describe herein, a transmission occasion may correspond to one or more time intervals during which the UE 215 may transmit uplink signaling (e.g., one or more uplink messages) to the network entity 205. In some examples, such as the example of FIG. 2, transmission occasions may correspond to PUSCH transmission occasions. That is, the transmission occasions 240 (e.g., each of the transmission occasions 240) may correspond to one or more time intervals during which the UE 215 may transmit uplink signaling to the network entity 205 via the PUSCH.

In some examples, the configured grant 235-a may schedule the transmission occasions 240 for the UE 215 across the resource allocation 230-a according to a periodicity 236-a. Additionally, the configured grant 235-b may schedule the transmission occasions 240 for the UE 215 across the resource allocation 230-b according to a periodicity 236-b. In some examples, the UE 215 and the network entity 205 may support multiple transmission occasions (e.g., configured grant PUSCH transmission occasions, such as the transmission occasions 240) in a period of a configured grant (e.g., a single configured grant PUSCH configuration). For example, the configured grant 235-a may schedule two of the transmission occasions 240 during a time period of the periodicity 236-a and the configured grant 235-b may schedule four of the transmission occasions 240 during a time period of the periodicity 236-b.

The UE 215 may use the configured grants 235 to transmit data traffic generated in accordance with one or more XR applications to the network entity 205 (e.g., without an additional uplink grant, such as may be transmitted to the UE 215 via downlink control information (DCI)). That is, the UE 215 may use the configured grant 235-a or the configured grant 235-b (or both) to transmit data traffic to the network entity 205 periodically (e.g., in a periodic manner). In some examples, however, the UE 215 may lack data traffic (e.g., periodic traffic) to transmit to the network entity 205 during one or more of the transmission occasions 240 scheduled via the configured grant 235-a or the configured grant 235-b (or both). In such examples, one or more of the transmission occasions 240 may be unused by the UE 215, which may reduce resource utilization and capacity within the wireless communications system 200.

In some examples, the wireless communications system 200 may support one or more techniques for indicating unused transmission occasions scheduled via an uplink configured grant. For example, the UE 215 (and the network entity 205) may support skipping indications for uplink configured grants, as described herein. As illustrated in the example of FIG. 2, the UE 215 may transmit one or more skipping indications (e.g., a skipping indication 255-a, a skipping indication 255-b, a skipping indication 255-c) to the network entity 205. The skipping indications 255 may indicate skipped occasions 245. As described herein, a skipped occasion may correspond to a transmission occasion during which uplink transmissions may be skipped. That is, the skipped occasions 245 may correspond to a transmission occasions (e.g., one of the transmission occasions 240) during which the UE 215 may skip uplink transmission. In other words, the skipped occasions 245 may correspond to a portion of the transmission occasions 240 that may be unused by the UE 215.

In some examples, the UE 215 may transmit the skipping indications 255 via uplink control signaling, such as via a MAC-CE or via UCI. For example, the UE 215 may transmit UCI (or a MAC-CE) that includes one or more of the skipping indications 255. The skipping indications 255 (e.g., each of the skipping indications 255) may indicate a set of uplink transmission occasions (e.g., from the transmission occasions 240 configured via the configured grant 235-a) during which the UE 215 may skip uplink transmissions. That is, the skipping indications 255 may indicate the skipped occasions 245. In some examples, the UE 215 may transmit the skipping indications 255 during one or more of the transmission occasions 240 (e.g., a transmission occasion scheduled via a configured grant). For example, the UE 215 may transmit UCI carrying a skipping indication (e.g., the skipping indication 255-a, the skipping indication 255-b, the skipping indication 255-c) during a transmission occasions (e.g., a transmission occasion 240-a, a transmission occasion 240-b, a transmission occasion 240-c) and on a corresponding component carrier. In such an example, the transmission occasions may be scheduled via a configured grant (e.g., the configured grant 235-a, the configured grant 235-b). In other words, the UE 215 (and the network entity 205) may support indication (e.g., dynamic indication) of unused configured grant PUSCH occasions based on UCI (e.g., a configured grant UCI (CG-UCI) or another type of UCI) transmitted by the UE 215. In some examples, the UE 215 may transmit the skipping indication based on determining that the UE 215 lacks data traffic to transmit during one or more of the skipped occasions 245 that may be indicated via the skipping indications 255. For example, the UE 215 may lack periodic data traffic associated with one or more XR applications during one or more of the skipped occasions 245. In other words, the UE 215 support CG-UCI for configured grant skipping indications in XR.

The UE 215 may transmit UCI (e.g., CG-UCI) carrying a skipping indication to indicate skipped occasions (e.g., configured grant skippings) in one or multiple configured grant configurations or one or multiple component carriers, or any combination thereof. As illustrated in the example of FIG. 2, the skipped occasions 245 may include one or more of the transmission occasions 240 scheduled via a single grant (e.g., the configured grant 235-a). For example, the UE 215 may transmit UCI carrying the skipping indications 255 to indicate the skipped occasions 245 (e.g., configured grant skippings) in the configured grant 235-a, which may be associated with the resource allocation 230-a (e.g., a single component carrier). That is, UCI transmitted during a transmission occasions (e.g., a configured grant PUSCH occasion, such as one of the transmission occasions 240) may be applicable to a single corresponding configured grant configuration. In other words, the UE 215 may transmit the skipping indications 255 via UCI during one or more of the transmission occasions 240. The skipping indications 255 may indicate one or more of the skipped occasions 245 that may occur subsequent to the one or more of the transmission occasions 240 during which the skipping indications 255 may be transmitted. Additionally, in some examples, the one or more of the skipped occasions 245 may correspond to transmission occasions scheduled for the UE 215 via a single configured grant (e.g., the configured grant 235-a).

In some examples, the UE 215 may use the UCI carrying the skipping indications 255 to indicate one or more configured grants (e.g., which configured grant(s)) the skipping indications 255 may apply to. That is, the network entity 205 may determine a configured grant that corresponds to a skipping indication based on an indication from the UE 215. In other words, the network entity 205 may determine the corresponding configured grant (e.g., the corresponding configured grant configuration and, if applicable, a corresponding component carrier) for a skipping indication based on one or more indications included in the UCI carrying the skipping indication. For example, the UCI may indicate an applicable CG-ID that corresponds to an applicable configured grant. Additionally, in some examples, the UCI may indicate an applicable component carrier index that may indicate an applicable component carrier. As illustrated in the example of FIG. 2, UCI carrying the skipping indications 255 may also carry a CG-ID corresponding to the configured grant 235-a. Additionally, in some examples, the UCI carrying the skipping indications 255 may also carry a component carrier index corresponding the component carrier associated with the resource allocation 230-a.

In some other examples, the network entity 205 may determine the corresponding configured grant based on one or more associations indicated to the UE 215 via RRC signaling (e.g., based on associations by RRC configuration). Additionally, or alternatively, the network entity 205 may determine the corresponding configured grant based on a transmission occasion (e.g., which configured grant PUSCH occasion) the UCI may be transmitted during. That is, by transmitting the UCI carrying the skipping indications 255 (e.g., the skipping indication 255-a, the skipping indication 255-b, the skipping indication 255-c) during one or more of the transmission occasions 240 scheduled via the configured grant 235-a, the network entity 205 may determine that the skipping indications 255 may be associated with at least the configured grant 235-a. For example, the UE 215 may transmit UCI carrying the skipping indication 255-a during the transmission occasion 240-a. In such an example, the skipping indication 255-a may be applicable to one or more of the transmission occasions 240 scheduled via the configured grant 235-a. That is, the skipping indication 255-a may indicate a first portion of the skipped occasions 245 scheduled via the configured grant 235-a. For example, the UE 215 may determine to skip uplink transmissions during one or more of the transmission occasions 240 that occur during a duration 250-a. In such an example, the UE 215 may transmit the skipping indication 255-a to the network entity 205 during the transmission occasion 240-a. The skipping indication 255-a may indicate (e.g., explicitly indicate) the skipped occasions 245 that occur during the duration 250-a via a bitmap. In some other examples, the skipping indication 255-a may indicate (e.g., implicitly indicate) the skipped occasions 245 that occur during the duration 250-a by indicating the duration 250-a.

In some examples, the UE 215 may transmit UCI carrying the skipping indication 255-b during the transmission occasion 240-b. In such an example, the skipping indication 255-b may be applicable to one or more of transmission occasions 240 scheduled via the configured grant 235-a. That is, the skipping indication 255-b may indicate a second portion of the skipped occasions 245 scheduled via the configured grant 235-a. For example, the UE 215 may determine to skip uplink transmissions during one or more of the transmission occasions 240 that occur during a duration 250-b. In such an example, the UE 215 may transmit the skipping indication 255-b to the network entity 205 during the transmission occasion 240-b. The skipping indication 255-b may indicate (e.g., explicitly indicate) the skipped occasions 245 that occur during the duration 250-b via a bitmap. In some other examples, the skipping indication 255-b may indicate (e.g., implicitly indicate) the skipped occasions 245 that occur during the duration 250-b by indicating the duration 250-b.

Additionally, or alternatively, in some examples, the UE 215 may transmit UCI carrying the skipping indication 255-c during the transmission occasion 240-c. In such an example, the skipping indication 255-b may be applicable to one or more of the transmission occasions 240 scheduled via the configured grant 235-a. That is, the skipping indication 255-b may indicate a third portion of the skipped occasions 245 scheduled via the configured grant 235-a. For example, the UE 215 may determine to skip uplink transmissions during one or more of the transmission occasions 240 that occur during a duration 250-c. In such an example, the UE 215 may transmit the skipping indication 255-c to the network entity 205 during the transmission occasion 240-c. The skipping indication 255-c may indicate (e.g., explicitly indicate) the skipped occasions 245 that occur during the duration 250-c via a bitmap. In some other examples, the skipping indication 255-c may indicate (e.g., implicitly indicate) the skipped occasions 245 that occur during the duration 250-c by indicating the duration 250-c. Although the example of FIG. 2 illustrates the skipped occasions 245 occurring within a single resource allocation (e.g., the resource allocation 230-a) and being associated with a single configured grant (e.g., the configured grant 235-a), the UE 215 may use skipping indications to indicate skipped occasions across one or multiple configured grants and across one or multiple resource allocations that may be associated with one or multiple component carriers.

As illustrated in the examples of FIG. 2, the UE 215 may transmit an uplink message 260 to the network entity 205 in accordance with the configured grants 235 and one or more of the skipping indications 255 (e.g., the UCI). For example, the UE 215 may transmit the uplink message 260 using one or more of the transmission occasions 240. In some examples, the network entity 205 may release one or more resources associated with (e.g., that occur during) the skipped occasions 245. That is, in response to receiving one or more of the skipping indications 255, the network entity 205 may release one or more resources of the resource allocation 230-a that occur during the skipped occasions 245. In some examples, by releasing resources that occur during the skipped occasions 245, the network entity 205 may reallocate the resources to one or more other UEs, which may lead to improved capacity within the wireless communications system 200, among other possible benefits.

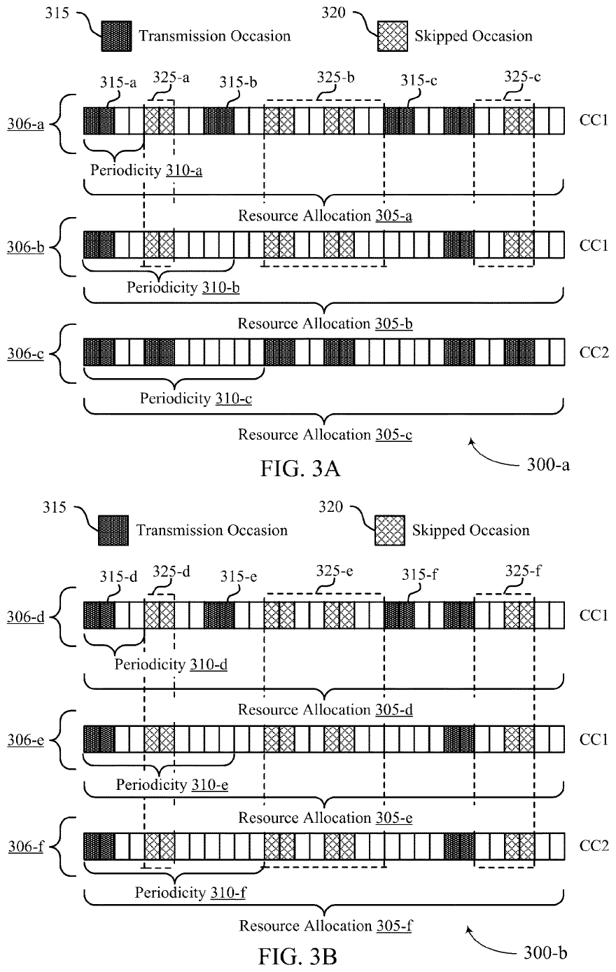

FIGS. 3A and 3B each illustrate an example of a configured grant diagram 300 that supports skipping indications for uplink configured grants in accordance with one or more aspects of the present disclosure. The configured grant diagrams 300 (e.g., a configured grant diagram 300-a and a configured grant diagram 300-b) may implement or be implemented to facilitate or realize one or more aspects of the wireless communications system 100 and the wireless communications system 200. For example, the configured grant diagrams 300 may be implemented at a UE and a network entity, which may be an example of the corresponding devices illustrated by and described with reference to FIGS. 1 and 2.

As illustrated in the example of FIGS. 3A and 3B, the network entity may configure the UE with multiple configured grants. For example, the network entity may transmit control signaling to the UE that indicates multiple resource allocations for the PUSCH and the multiple resources allocations may be associated with multiple configured grants and one or more component carriers. In some examples, the UE may support one or more techniques for indicating unused transmission occasions scheduled via one or more of the configured grants. For example, the UE may transmit UCI to the network entity that may include a skipping indication. The skipping indication may indicate one or more transmission occasions that may be scheduled via one or more of the configured grants and during which the UE may skip uplink transmissions. That is, the skipping indication may indicate skipped occasions 320, which may correspond to a portion of the transmission occasions 315 during which the UE may skip uplink transmissions. In some examples, the skipped occasions 320 include one or more of the transmission occasions 315 on a single component carrier. For example, UCI transmitted during one or more of the transmission occasions 315 may be applicable to multiple configured grants (e.g., multiple corresponding configured grant configurations, such as a configured grant 306-a and a configured grant 306-b or a configured grant 306-d and a configured grant 306-e) in a same component carrier. In other words, the UE may transmit a skipping indication via UCI during one or more of the transmission occasions 315 and the skipping indication may be applicable to multiple of the configured grants 306 that may be associated with a single (e.g., the same) component carrier. That is, as illustrated in the example of FIG. 3A, a skipping indication may indicate skipped occasions 320 across multiple of the configured grants 306 that may be associated with a same component carrier.

For example, the network entity may indicate (e.g., configure the UE with) a resource allocation 305-a, a resource allocation 305-b, and a resource allocation 305-c to the UE. The resource allocation 305-a and the resource allocation 305-b may be associated with a first component carrier (e.g., CC1), while the resource allocation 305-c may be associated with a second component carrier (e.g., CC2). Additionally, the resource allocation 305-a, the resource allocation 305-b, and the resource allocation 305-c may be associated with multiple configured grants. For example, the resource allocation 305-a may be associated with a configured grant 306-a, the resource allocation 305-b may be associated with a configured grant 306-b, and the resource allocation 305-c may be associated with a configured grant 306-c. The configured grant 306-a may schedule one or more of the transmission occasions 315 for the UE across the resource allocation 305-a, the configured grant 306-b may schedule one or more of the transmission occasions 315 for the UE across the resource allocation 305-b, and configured grant 306-c may schedule one or more of the transmission occasions 315 for the UE across the resource allocation 305-c. In some examples, the configured grant 306-a may schedule one or more of the transmission occasions 315 for the UE across the resource allocation 305-a according to a periodicity 310-a. Additionally, the configured grant 306-b may schedule one or more of the transmission occasions 315 for the UE across the resource allocation 305-b according to a periodicity 310-b. In some examples, the configured grant 306-c may schedule one or more of the transmission occasions 315 for the UE across the resource allocation 305-c according to a periodicity 310-c.

In some examples, the network entity may determine the corresponding configured grants (e.g., the corresponding configured grant configurations and the corresponding component carrier) based on one or more indications included in the UCI (e.g., the UCI carrying the skipping indication). For example, the UCI may indicate multiple applicable CG-IDs that corresponds to multiple applicable configured grants. Additionally, in some examples, the UCI may indicate an applicable component carrier index that may indicate an applicable component carrier. As illustrated in the example of FIG. 3A, UCI carrying the skipping indication may carry a first CG-ID (CG-ID1) corresponding to the configured grant 306-a and a second CG-ID (CG-ID2) corresponding to the configured grant 306-b. Additionally, or alternatively, the UCI carrying the skipping indication may carry a component carrier index corresponding to the first component carrier that is associated with the resource allocation 305-a and the resource allocation 305-b.

In some other examples, the network entity may determine corresponding configured grants based on one or more associations indicated to the UE via RRC signaling (e.g., based on associations by RRC configuration). Additionally, or alternatively, the network entity may determine the corresponding configured grants based on which component carrier the UCI carrying the skipping indication may be transmitted on. That is, by transmitting the UCI carrying a skipping indication on a component carrier the network entity may determine that the skipping indication is applicable to the component carrier (e.g., that skipped occasions indicated via the skipping indication may be associated with at least the component carrier). For example, the UE may transmit UCI carrying a first skipping indication during a transmission occasion 315-a. In such an example, the first skipping indication may be applicable to configured grants (e.g., any configured grant) associated with the first component carrier, which the UE used to transmit the UCI (e.g., the component carrier associated with the resource allocation 305-a and the resource allocation 305-b). For example, the UE may determine to skip uplink transmissions during one or more of the transmission occasions 315 that occur during a duration 325-a and on the first component carrier. In such an example, the UE may transmit the first skipping indication to the network entity during the transmission occasion 315-a and on the first component carrier. The first skipping indication may indicate the duration 325-a or the first skipping indication may indicate the skipped occasions 320 that occur during the duration 325-a.

Additionally, or alternatively, the UE may determine to skip uplink transmissions during one or more of the transmission occasions 315 that occur during a duration 325-b. In such an example, the UE may transmit a second skipping indication to the network entity during the transmission occasion 315-b. The second skipping indication may indicate the duration 325-b or the second skipping indication may indicate the skipped occasions 320 that occur during the duration 325-b. In some examples, the UE may determine to skip uplink transmissions during one or more of the transmission occasions 315 that occur during a duration 325-c. In such an example, the UE may transmit a third skipping indication to the network entity during the transmission occasion 315-c. The third skipping indication may indicate the duration 325-c or the third skipping indication may indicate the skipped occasions 320 that occur during the duration 325-c.

In some other examples, UCI transmitted during a transmission occasion (e.g., a configured grant PUSCH occasion) may be applicable to multiple corresponding configured grant configurations in multiple (e.g., different) component carriers. For example, the UE may transmit a skipping indication via UCI during one or more of the transmission occasions 315 and the skipping indication may be applicable to multiple of the configured grants 306 that may be associated with multiple (e.g., different) component carriers. That is, as illustrated in the example of FIG. 3B, a skipping indication may indicate skipped occasions 320 across multiple of the configured grants 306 that may be associated with multiple component carriers.

For example, the network entity may transmit control signaling to the UE that indicates one or more resource allocations 305 for the PUSCH that may be associated with one or more of the configured grants 306 and one or more component carrier. As illustrated in the example of FIG. 3B, the network entity may indicate a resource allocation 305-d, a resource allocation 305-e, and a resource allocation 305-f to the UE. The resource allocation 305-d and the resource allocation 305-e may be associated with a first component carrier (e.g., CC1), while the resource allocation 305-f may be associated with a second component carrier (e.g., CC2). Additionally, the resource allocation 305-d, the resource allocation 305-e, and the resource allocation 305-f may be associated with multiple configured grants. For example, the resource allocation 305-d may be associated with a configured grant 306-d, the resource allocation 305-e may be associated with a configured grant 306-e, and the resource allocation 305-f may be associated with a configured grant 306-f. The configured grant 306-d may schedule one or more of the transmission occasions 315 for the UE across the resource allocation 305-d, the configured grant 306-e may schedule one or more of the transmission occasions 315 for the UE across the resource allocation 305-e, and configured grant 306-f may schedule one or more of the transmission occasions 315 for the UE across the resource allocation 305-f. In some examples, the configured grant 306-d may schedule one or more of the transmission occasions 315 for the UE across the resource allocation 305-d according to a periodicity 310-d. Additionally, the configured grant 306-e may schedule one or more of the transmission occasions 315 for the UE across the resource allocation 305-e according to a periodicity 310-e. In some examples, the configured grant 306-f may schedule one or more of the transmission occasions 315 for the UE across the resource allocation 305-f according to a periodicity 310-f.

In some examples, the network entity may determine multiple corresponding configured grants (e.g., multiple corresponding configured grant configurations and the corresponding component carrier) based on one or more indications included in UCI (e.g., UCI carrying the skipping indication). For example, the UCI carrying the skipping indication may indicate multiple applicable CG-IDs that corresponds to multiple applicable configured grant. Additionally, in some examples, the UCI may indicate an applicable component carrier index that may indicate an applicable component carrier. As illustrated in the example of FIG. 3B, the UCI carrying the skipping indication may carry a first CG-ID (CG-ID 1) corresponding to the configured grant 306-d, a second CG-ID (CG-ID2) corresponding to the configured grant 306-e, and a third CG-ID (CG-ID3) corresponding to the configured grant 306-f. Additionally, or alternatively, the UCI carrying the skipping indication may carry a first component carrier index corresponding to the first component carrier associated with the resource allocation 305-d and the resource allocation 305-e and a second component carrier index corresponding to the second component carrier associated with the resource allocation 305-f.

In some other examples, the network entity may determine the corresponding configured grant based on one or more associations indicated to the UE via RRC signaling (e.g., based on associations by RRC configuration). Additionally, or alternatively, the network entity may determine the corresponding configured grants based on a component carrier (e.g., which component carrier) the UCI carrying the skipping indication may be transmitted on. For example, the UE may transmit the UCI carrying a first skipping indication during a transmission occasion 315-d. In such an example, the first skipping indication may be applicable to one or more configured grants (e.g., any configured grant) associated with the first component carrier used to transmit the UCI. In some examples, the first skipping indication may also be applicable to one or more other component carriers (e.g., the second component carrier) that may be associated with the first component carrier. For example, one or more associations indicated to the UE via RRC signaling may indicate that the first component carrier is associated with the second component carrier. Accordingly, the network entity may determine that the UCI is applicable to the first component carrier and the second component carrier if the UCI is transmitted via the first component carrier or the second component carrier. For example, the UE may determine to skip uplink transmissions during one or more of the transmission occasions 315 that occur during a duration 325-d. In such an example, the UE may transmit the first skipping indication to the network entity during the transmission occasion 315-d. The first skipping indication may indicate the duration 325-d or the first skipping indication may indicate the skipped occasions 320 that occur during the duration 325-d. Additionally, or alternatively, the UE may determine to skip uplink transmissions during one or more of the transmission occasions 315 that occur during a duration 325-e. In such an example, the UE may transmit a second skipping indication to the network entity during the transmission occasion 315-e. The second skipping indication may indicate the duration 325-e or the second skipping indication may indicate the skipped occasions 320 that occur during the duration 325-e. In some examples, the UE may determine to skip uplink transmissions during one or more of the transmission occasions 315 that occur during a duration 325-f. In such an example, the UE may transmit a third skipping indication to the network entity during the transmission occasion 315-f. The third skipping indication may indicate the duration 325-f or the third skipping indication may indicate the skipped occasions 320 that occur during the duration 325-f. In some examples, by transmitting one or more skipping indications to the network entity, the UE may increase a capacity of wireless communications at the network entity, among other possible benefits.

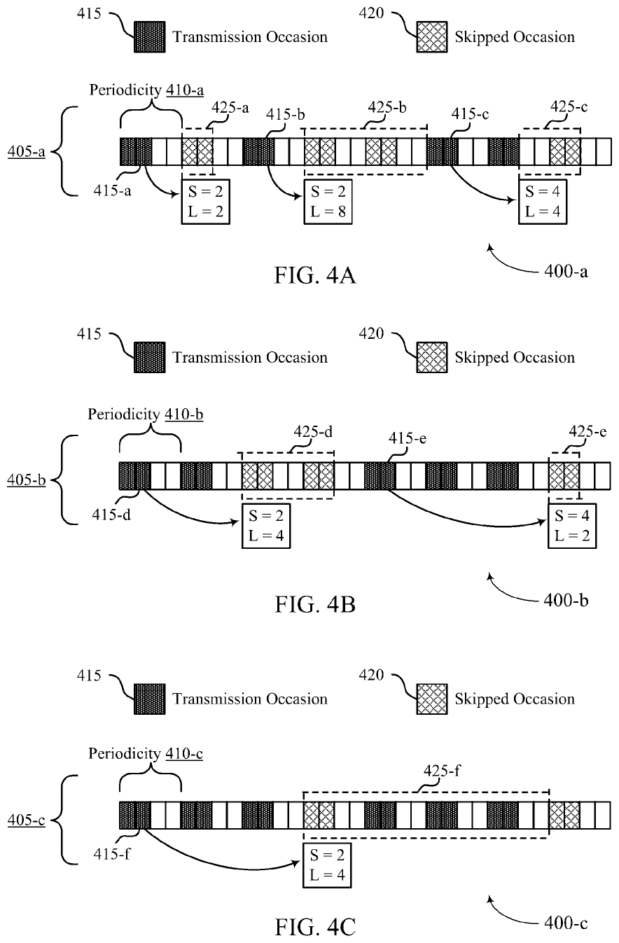

FIGS. 4A, 4B, and 4C each illustrate an example of a skipping indication scheme 400 that supports skipping indications for uplink configured grants in accordance with one or more aspects of the present disclosure. The skipping indication schemes 400 (e.g., a skipping indication scheme 400-a, a skipping indication scheme 400-b, and a skipping indication scheme 400-c) may implement or be implemented to facilitate or realize one or more aspects of the wireless communications system 100, the wireless communications system 200, and the configured grant diagrams 300. For example, the skipping indication schemes 400 may be implemented at a UE and a network entity, which may be an example of the corresponding devices illustrated by and described with reference to FIGS. 1, 2, 3A, and 3B.

The network entity may configure the UE with multiple configured grants. In some examples, the UE may support one or more techniques for indicating unused transmission occasions scheduled via one or more of the configured grants. For example, the UE may transmit UCI (e.g., CG-UCI) carrying a skipping indication to indicate configured grant skippings (e.g., skipped transmission occasions scheduled at the UE via one or more of the configured grants). That is, the UE may transmit UCI to the network entity that may include a skipping indication. The skipping indication may indicate one or more transmission occasions (e.g., transmission occasions 415) during which the UE may skip uplink transmissions. That is, the skipping indication may indicate one or more of the skipped occasions 420, which may correspond to a portion of the transmission occasions 415 during which the UE may skip uplink transmissions. In some examples, the skipping indication may indicate a duration (e.g., a length (L)) during which the UE may skip uplink transmissions. Additionally, or alternatively, the skipping indication may indicate a timing offset (e.g., a starting offset (S)) associated with the duration. That is, in some examples, the skipping indication may indicate the starting offset (S) and the length (L) for the skipped transmission occasions (e.g., configured grant PUSCH occasions). In such examples, the duration (L) may begin after a time, which may be determined in accordance with the following Equation 1:

$$n + S \qquad ( 1 )$$

in which n may correspond to a time interval (e.g., a slot or a symbol) used for transmission of the UCI carrying the skipping indication (e.g., a slot with the CG-UCI transmission). The timing offset (S) and the duration (L) may each correspond to a respective quantity of time intervals (e.g., a respective quantity of slots, a respective quantity of symbols), a respective quantity of uplink transmission occasions, a respective quantity of time periods, or a respective quantity of time units, or any combination thereof.

As illustrated in the example of FIG. 4A, the timing offset (S) and the duration (L) may each correspond to a respective quantity time intervals (e.g., slots or symbols), during which the UE may skip configured grant PUSCH transmissions. That is, the duration (L) and the timing offset (S) may indicate a quantity of slots or a quantity of symbols in which the UE may skip uplink transmissions. In such examples, a portion of skipped occasions 420 may occur during the duration. For example, the network entity may transmit control signaling to the UE that indicates a resource allocation for the PUSCH, which may include multiple time intervals on a component carrier. The resource allocation may be associated a configured grant 405-a. The configured grant 405-a may schedule one or more of the transmission occasions 415 across the resource allocation in accordance with a periodicity 410-a.

In the example of FIG. 4A, the UE may determine to skip uplink transmissions during a duration 425-a, a duration 425-b, and a duration 425-c. Accordingly, the UE may transmit UCI to the network entity during a transmission occasion 415-a. The UCI may carry a first skipping indication that indicates a timing offset of S=2 and a duration of L=2. That is, the first skipping indication may indicate one or more of the skipped occasions 420 that occur within the duration 425-a, which may have a temporal length of two time intervals (e.g., two slots or two symbols) and may begin two time intervals (e.g., two slots or two symbols) after the transmission occasion 415-a. Additionally, or alternatively, the UE may transmit UCI to the network entity during a transmission occasion 415-b. The UCI may carry a second skipping indication that indicates a timing offset of S=2 and a duration of L=8. That is, the skipping indication may indicate one or more of the skipped occasions 420 that occur within the duration 425-b, which may have a temporal length of eight time intervals (e.g., eight slots or eight symbols) and may begin two time intervals (e.g., two slots or two symbols) after the transmission occasion 415-b. In some examples, the UE may transmit UCI to the network entity during a transmission occasion 415-c. The UCI may carry a third skipping indication that indicates a timing offset of S=4 and a duration of L=4. That is, the skipping indication may indicate one or more of the skipped occasions 420 that occur within the duration 425-c, which may have a temporal length of four time intervals (e.g., four slots or four symbols) and may begin four time intervals (e.g., four slots or four symbols) after the transmission occasion 415-c.

As illustrated in the example of FIG. 4B, the timing offset (S) and the duration (L) may each correspond to a respective quantity of transmission occasions (e.g., configured grant PUSCH occasions). For example, the network entity may transmit control signaling to the UE that indicates a resource allocations for the PUSCH, which may include multiple time intervals on a component carrier. The resource allocation may be associated a configured grant 405-b. The configured grant 405-b may schedule one or more of the transmission occasions 415 across the resource allocation in accordance with a periodicity 410-b. In the example of FIG. 4B, the UE may determine to skip uplink transmissions during a duration 425-d and a duration 425-e. Accordingly, the UE may transmit UCI to the network entity during a transmission occasion 415-d. The UCI may carry a first skipping indication that indicates a timing offset of S=2 and a duration of L=4. In such an example, the skipping indication may indicate the UE skips uplink transmissions during four transmission occasions that occur two transmission occasions after the transmission occasion 415-d. That is, the first skipping indication may indicate one or more of the skipped occasions 420 that occur during the duration 425-d, which may have a temporal length that spans at least four transmission occasions and which may begin two transmission occasions after the transmission occasion 415-d. Additionally, or alternatively, the UE may transmit UCI to the network entity during a transmission occasion 415-e. The UCI may carry a second skipping indication that indicates a timing offset of S=4 and a duration of L=2. That is, the skipping indication may indicate one or more of the skipped occasions 420 that occur within the duration 425-e, which may have a temporal length that spans at least two transmission occasion and which may begin four transmission occasions after the transmission occasion 415-e.

As illustrated in the example of FIG. 4C, the timing offset (S) and the duration (L) may each correspond to a respective quantity of time periods (e.g., configured grant periodicities). For example, the network entity may transmit control signaling to the UE that indicates a resource allocations for the PUSCH, which may include multiple time intervals on a component carrier. The resource allocation may be associated a configured grant 405-c. The configured grant 405-c may schedule one or more of the transmission occasions 415 across the resource allocation in accordance with a periodicity 410-c. In the example of FIG. 4C, the UE may determine to skip uplink transmissions during a duration 425-f. Accordingly, the UE may transmit UCI to the network entity during a transmission occasion 415-f. The UCI may carry a skipping indication that indicates a timing offset of S=2 and a duration of L=4. In such an example, the skipping indication may indicate the UE skips uplink transmissions across four time periods (e.g., consecutive time periods) that begin two time periods after the transmission occasion 415-f. Additionally, a temporal length of a time period may be based on (e.g., correspond to, include) the periodicity 410-c (e.g., the periodicity of a corresponding configured grant, the configured grant 405-c). That is, the skipping indication may indicate one or more of the skipped occasions 420 that occur during the duration 425-f, which may have a temporal length of four time periods and which may begin two transmission occasions after the transmission occasion 415-d. In some other examples, the timing offset (S) and the duration (L) may correspond to a quantity of time units (e.g., ms). In some examples, by transmitting one or more skipping indications to the network entity, the UE may increase resource utilization at the network entity, among other possible benefits.

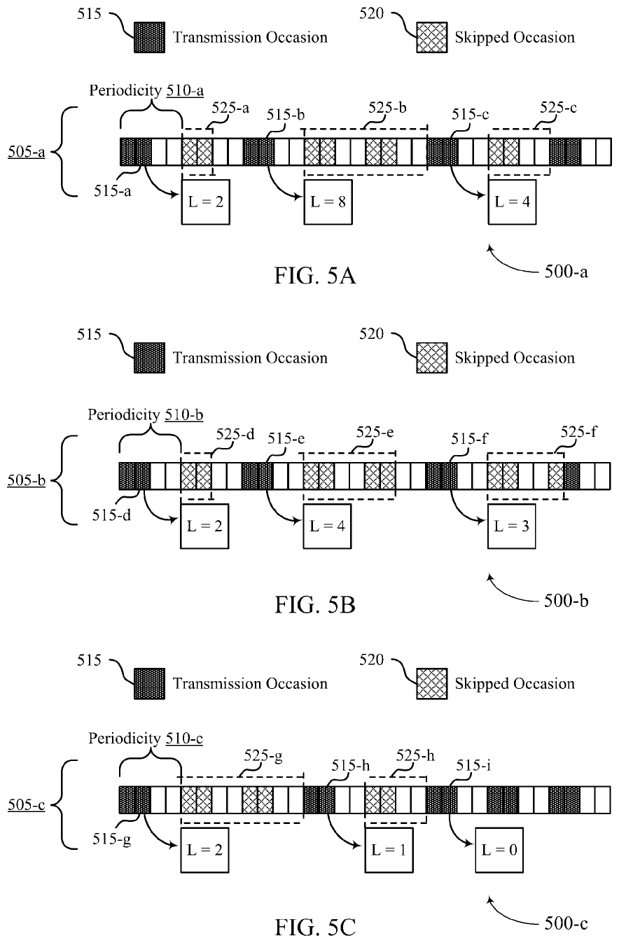

FIGS. 5A, 5B, and 5C each illustrate an example of a skipping indication scheme 500 that supports skipping indications for uplink configured grants in accordance with one or more aspects of the present disclosure. The skipping indication schemes 500 (e.g., a skipping indication scheme 500-a, a skipping indication scheme 500-b, and a skipping indication scheme 500-c) may implement or be implemented to facilitate or realize one or more aspects of the wireless communications system 100, the wireless communications system 200, the configured grant diagrams 300, and the skipping indication schemes 400. For example, the skipping indication schemes 500 may be implemented at a UE and a network entity, which may be an example of the corresponding devices illustrated by and described with reference to FIGS. 1, 2, 3A, 3B, 4A, 4B, and 4C.

The network entity may configure the UE with multiple configured grants. In some examples, the UE may support one or more techniques for indicating unused transmission occasions scheduled via one or more of the configured grants. For example, the UE may transmit UCI to the network entity that may include a skipping indication, which may indicate one or more transmission occasions during which the UE may skip uplink transmissions. That is, the skipping indication may indicate one or more of the skipped occasions 520, which may correspond to one or more transmission occasions 515 during which the UE may skip uplink transmissions. In some examples, the skipping indication may indicate a duration (e.g., a length (L)) during which the UE may skip uplink transmissions. The duration may, in some instances, begin after a timing offset (X). For example, the skipping indication may indicate a duration (e.g., the length (L)) after the timing offset (X) and during which the UE may skip uplink transmissions. In such an example, the duration (L) may begin after a time, which may be determined in accordance with the following Equation 2:

$$n + X \qquad ( 2 )$$

in which n may correspond to a time interval used for transmission of the UCI carrying the skipping indication (e.g., a slot or a symbol with the CG-UCI transmission). That is, the skipping indication may indicate a length (L) of skipped occasions (e.g., skipped configured grant PUSCH occasions) after time (n+X). In some examples, the timing offset (X) may correspond to an application time (e.g., a predetermined application time, a fixed application time) for the skipping indication (e.g., an uplink skipping indication). That is, the timing offset (X) may be determined at the UE based on an indication (e.g., a configuration, a pre-configuration) from the network entity or the UE may be otherwise configured with the timing offset (X). The duration (L) may correspond to a quantity of time intervals (e.g., slots or symbols), a quantity of uplink transmission occasions, a quantity of time periods, or a quantity of time units, or any combination thereof. In some examples, the timing offset (X) may correspond to a quantity of time intervals (e.g., slots or symbols), a quantity of uplink transmission occasions, a quantity of time periods, or a quantity of time units, or any combination thereof.

As illustrated in the example of FIG. 5A, the timing offset (X) and the duration (L) may each correspond to a respective quantity of time intervals (e.g., a respective quantity of slots, a respective quantity of symbols) during which the UE may skip configured grant PUSCH transmission (e.g., in which there may be no configured grant PUSCH transmissions). In the example of FIG. 5A, the UE may be configured with a timing offset of X=2. That is, the UE may transmit UCI that indicates a duration (L) that corresponds to a quantity of slots or a quantity of symbols in which the UE may skip uplink transmissions and the quantity of slots or the quantity of symbols may occur two slots or two symbols after the UE may transmit the UCI. In such examples, the skipped occasions 520 may occur during the indicated duration (L). For example, the network entity may transmit control signaling to the UE that indicates a resource allocations for the PUSCH, which may include multiple time intervals on a component carrier. The resource allocation may be associated a configured grant 505-a. The configured grant 505-a may schedule one or more transmission occasions 515 across the resource allocation in accordance with a periodicity 510-a.

In the example of FIG. 5A, the UE may determine to skip uplink transmissions during a duration 525-a, a duration 525-b, and a duration 525-c. Accordingly, the UE may transmit UCI to the network entity during a transmission occasion 515-a. The UCI may carry a first skipping indication that indicates a duration of L=2. That is, the first skipping indication may indicate skipped occasions 520 that occur within the duration 525-a, which may have a temporal length of two time intervals (e.g., two slots or two symbols) and may begin two time intervals (e.g., two slots or two symbols) after the transmission occasion 515-a. Additionally, or alternatively, the UE may transmit UCI to the network entity during a transmission occasion 515-b. The UCI may carry a second skipping indication that indicates a timing offset of L=8. That is, the skipping indication may indicate skipped occasions 520 that occur within the duration 525-b, which may have a temporal length of eight time intervals (e.g., eight slots or eight symbols) and may begin two time intervals (e.g., two slots or two symbols) after the transmission occasion 515-b. In some examples, the UE may transmit UCI to the network entity during a transmission occasion 515-c. The UCI may carry a third skipping indication that indicates a timing offset of L=4. That is, the skipping indication may indicate skipped occasions 520 that occur within the duration 525-c, which may have a temporal length of four time intervals (e.g., four slots or four symbols) and may begin four time intervals (e.g., four slots or four symbols) after the transmission occasion 515-c.

As illustrated in the example of FIG. 5B, the duration (L) may correspond to a quantity of transmission occasions (e.g., configured grant PUSCH occasions). For example, the UE may be configured with a timing offset of X=0, in which X may correspond to a quantity of transmission occasions (e.g., configured grant PUSCH occasions). The network entity may transmit control signaling to the UE that indicates a resource allocations for the PUSCH, which may include multiple time intervals on a component carrier. The resource allocation may be associated a configured grant 505-b. The configured grant 505-b may schedule one or more transmission occasions 515 across the resource allocation in accordance with a periodicity 510-b. In the example of FIG. 5B, the UE may determine to skip uplink transmissions during a duration 525-d, a duration 525-e, and a duration 525-f. Accordingly, the UE may transmit UCI to the network entity during a transmission occasion 515-d. The UCI may carry a first skipping indication that indicates a duration of L=2. In such an example, the skipping indication may indicate that the UE skips uplink transmissions during two transmission occasions that occur after the transmission occasion 515-d. That is, the first skipping indication may indicate skipped occasions 520 that occur during the duration 525-d, which may have a temporal length that spans at least two transmission occasions and which may begin after the transmission occasion 515-d (e.g., at a next transmission occasion after the transmission occasion 515-d). Additionally, or alternatively, the UE may transmit UCI to the network entity during a transmission occasion 515-e. The UCI may carry a second skipping indication that indicates a duration of L=4. That is, the skipping indication may indicate skipped occasions 520 that occur within the duration 525-e, which may have a temporal length that spans at least four transmission occasions, and which may begin after the transmission occasion 415-e. In some examples, the UE may transmit UCI to the network entity during a transmission occasion 515-f. The UCI may carry a third skipping indication that indicates a duration of L=3. That is, the skipping indication may indicate skipped occasions 520 that occur within the duration 525-f, which may have a temporal length that spans at least three transmission occasion and which may begin after the transmission occasion 515-f.

As illustrated in the example of FIG. 5C, the duration (L) may correspond to a quantity of time periods (e.g., configured grant periodicities). Additionally, in the example of FIG. 5C, the UE may be configured with a timing offset of X=0, in which X may correspond to a quantity of time periods. For example, the network entity may transmit control signaling to the UE that indicates a resource allocations for the PUSCH, which may include multiple time intervals on a component carrier. The resource allocation may be associated a configured grant 505-c. The configured grant 505-c may schedule one or more transmission occasions 515 across the resource allocation in accordance with a periodicity 510-c. In the example of FIG. 5C, the UE may determine to skip uplink transmissions during a duration 525-g and a duration 525-h. Accordingly, the UE may transmit UCI to the network entity during a transmission occasion 515-g. The UCI may carry a first skipping indication that indicates a duration of L=2. In such an example, the first skipping indication may indicate the UE skips uplink transmissions across two consecutive time periods that begin after a time period that includes the transmission occasion 515-g. Additionally, a temporal length of a time period may correspond to the periodicity 510-c (e.g., the periodicity of a corresponding configured grant, the configured grant 505-c). That is, the first skipping indication may indicate skipped occasions 520 that occur during the duration 525-g, which may have a temporal length of two time periods and which may begin after the transmission occasion 515-g. Additionally, or alternatively, the UE may transmit UCI to the network entity during a transmission occasion 515-h. The UCI may carry a second skipping indication that indicates a duration of L=1. In such an example, the second skipping indication may indicate the UE skips uplink transmissions across a time periods that begins after a time period that includes the transmission occasion 515-h. The time period may be based on the periodicity 510-c (e.g., the periodicity of a corresponding configured grant, the configured grant 505-c). That is, the second skipping indication may indicate skipped occasions 520 that occur during the duration 525-h, which may have a temporal length of one time period and which may begin after the transmission occasion 515-h. In some examples, the UE may determine to refrain from skipping uplink transmission occasions. In such an example, the UE may transmit UCI to the network entity during a transmission occasion 515-i. The UCI may carry a third skipping indication that indicates a duration of L=0. In such an example, the third skipping indication may indicate that the UE skips no (e.g., 0) uplink transmissions after a time period that includes the transmission occasion 515-i. In some other examples, the timing offset (X) and the duration (L) may correspond to a quantity of time units (e.g., ms).

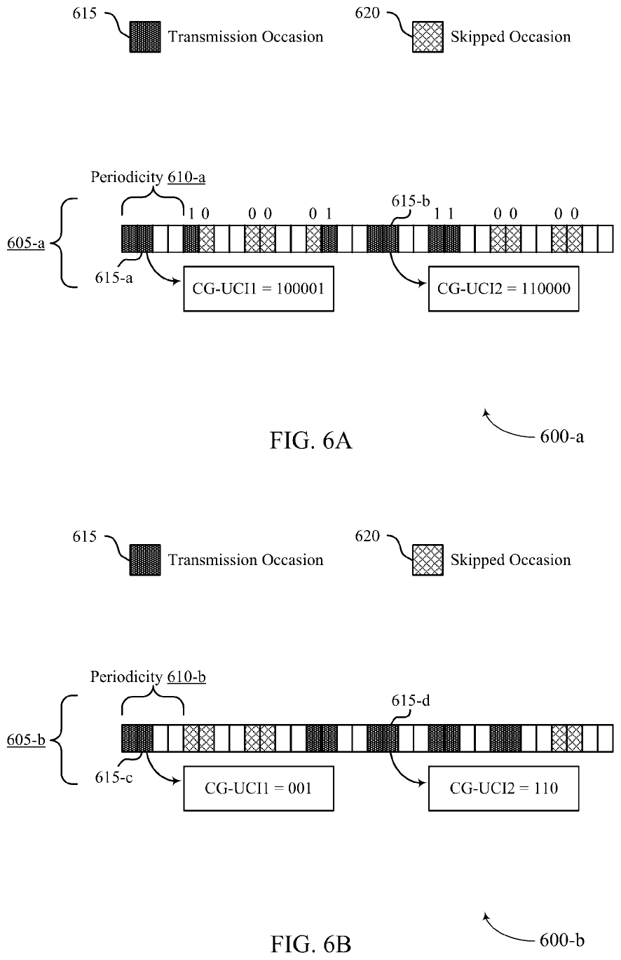

FIGS. 6A and 6B each illustrate an example of a skipping indication scheme 600 that supports skipping indications for uplink configured grants in accordance with one or more aspects of the present disclosure. The skipping indication schemes 600 (e.g., a skipping indication scheme 600-a and a skipping indication scheme 600-b) may implement or be implemented to facilitate or realize one or more aspects of the wireless communications system 100, the wireless communications system 200, the configured grant diagrams 300, the skipping indication schemes 400, and the skipping indication schemes 500. For example, the skipping indication schemes 600 may be implemented at a UE and a network entity, which may be an example of the corresponding devices illustrated by and described with reference to FIGS. 1, 2, 3A, 3B, 4A, 4B, 4C, 5A, 5B, and 5C.

The network entity may configure the UE with multiple configured grants. In some examples, the UE may support one or more techniques for indicating unused transmission occasions scheduled via one or more of the configured grants. For example, the UE may transmit UCI to the network entity that may include a skipping indication, which may indicate one or more transmission occasions during which the UE may skip uplink transmissions. That is, the skipping indication may indicate one or more of the skipped occasions 620, which may correspond to a portion of transmission occasions 615 during which the UE may skip uplink transmissions. In some examples, the skipping indication may indicate selectively skipped uplink transmission occasions. For example, the skipping indication may indicate selectively skipped uplink transmission occasions (e.g., configured grant PUSCH transmissions) after a timing offset (X). That is, the skipped uplink transmission occasions may occur after a time that may be based on the timing offset (X). For example, the skipped uplink transmission occasions (e.g., the skipped occasions 620) may occur after a time determined in accordance with Equation 2 (e.g., after time n+X). In some examples, the timing offset (X) may correspond to an application time (e.g., a predetermined application time, a fixed application time) for the skipping indication (e.g., an uplink skipping indication). That is, the timing offset (X) may be determined at the UE based on an indication (e.g., a configuration, a pre-configuration) from the network entity or the UE may be otherwise configured with the timing offset. The selectively skipped uplink transmission occasions (e.g., configured grant PUSCH transmissions) may be consecutive or non-consecutive. For example, the UE may transmit UCI that may include a bitmap that indicates the selectively skipped transmission occasions (e.g., the skipped occasions 620). In some examples, a length of the bitmap (e.g., the UCI) may be indicated to (e.g., configured at, preconfigured at) the UE via RRC signaling or the UE may be otherwise configured with the length of the bitmap.

As illustrated in the example of FIG. 6A, the UE may transmit a bitmap that may indicate skipped occasions 620 (e.g., skipped configured grant PUSCH transmissions) as a quantity of transmission occasions (e.g., configured grant occasions). That is, a bit (e.g., each bit) included in the bit map may correspond to a respective transmission occasion scheduled via a configured grant. A bit with a value of 1 may correspond to a used transmission occasion (e.g., a transmission occasion 615) and a bit with a value of 0 may correspond to an unused transmission occasion (e.g., a skipped occasion 620). For example, the network entity may transmit control signaling to the UE that indicates a resource allocation for the PUSCH, which may include multiple time intervals on a component carrier. The resource allocation may be associated a configured grant 605-a. The configured grant 605-b may schedule one or more of the transmission occasions 615 across the resource allocation in accordance with a periodicity 610-a. Additionally, in the example of FIG. 6A, the UE may be configured with a timing offset of X=0, in which X may correspond to a quantity of transmission occasions.

The UE may transmit UCI during a transmission occasion 615-a that may indicate a first bitmap CG-UC1=100001. In such an example, a bit of the first bitmap may correspond to a respective transmission occasion (e.g., one of the transmission occasions 615) scheduled via the configured grant 605-a. That is, the first bitmap may include six bits that may correspond to six transmission occasions that occur after the transmission occasion 615-a. The first bitmap CG-UC1=100001 may indicate that of the six transmission occasions the UE may use the first transmission occasion and the last transmission occasion for uplink transmissions. That is, the first transmission occasion and the last transmission occasion of the six transmission occasions may be used for uplink transmissions. Additionally, the first bitmap CG-UC1=100001 may indicate that four consecutive uplink transmission occasions that occur between the first transmission occasion and the last transmission occasion are skipped occasions 620. Additionally, the UE may transmit UCI during a transmission occasion 615-b that may indicate a second bitmap CG-UC2=110000. In such an example, a bit of the second bitmap may correspond to a respective transmission occasion (e.g., one of the transmission occasions 615) scheduled via the configured grant 605-b. That is, the second bitmap may include six bits that may correspond to six transmission occasions that occur after the transmission occasion 615-b. The second bitmap CG-UC2=110000 may indicate that of the six transmission occasions the UE may use the first transmission occasion and the second transmission occasion. That is, the second bitmap may indicate that the first transmission occasion and the second transmission occasion are used for uplink transmissions. Additionally, the second bitmap may indicate that transmission occasions that occur after the second transmission occasion are skipped occasions 620.

As illustrated in the example of FIG. 6B, the UE may transmit a bitmap that may indicate skipped occasions 620 (e.g., skipped configured grant PUSCHs) as a quantity of time periods (e.g., configured grant periodicities). For example, the network entity may transmit control signaling to the UE that indicates a resource allocation for the PUSCH, which may include multiple time intervals on a component carrier. The resource allocation may be associated a configured grant 605-b. The configured grant 605-b may schedule one or more of the transmission occasions 615 across the resource allocation in accordance with a periodicity 610-b. Additionally, in the example of FIG. 6B, the UE may be configured with a timing offset of X=0, in which X may correspond to a quantity of time periods (e.g., configured grant periodicities).

The UE may transmit UCI during a transmission occasion 615-c that may indicate a first bitmap CG-UC1=001. In such an example, a bit of the first bitmap may correspond to a respective transmission occasion (e.g., one of the transmission occasions 615) scheduled via the configured grant 605-b. That is, the first bitmap may include three bits that may correspond to three time periods that occur after the transmission occasion 615-c. The first bitmap CG-UC1=001 may indicate that the UE may use transmission occasions that occur during the last time period. That is, the first bitmap may indicate that one or more of the transmission occasions 615 that occur during the last time period are used for uplink transmissions. The first bitmap may also indicate that transmission occasions that occur during the first time period and the second time period are skipped occasions 620. Additionally, the UE may transmit UCI during a transmission occasion 615-d that may indicate a second bitmap CG-UC2=110. In such an example, a bit of the second bitmap may correspond to a respective transmission occasion (e.g., one of the transmission occasions 615) scheduled via the configured grant 605-b. That is, the second bitmap may include three bits that may correspond to three time periods that occur after the transmission occasion 615-d. The second bitmap CG-UC2=110 may indicate that the UE may use transmission occasions that occur during the first two time periods after the transmission occasion 615-d. That is, the second bitmap may indicate that transmission occasions that occur during the first two time periods after the transmission occasion 615-d are used for uplink transmissions. Additionally, or alternatively, the second bitmap may indicate that transmission occasions that occur during the last time period are skipped occasions 620. In some examples, using a bitmap to indicate skipped occasions 620 may lead to increased capacity and improved resource utilization for wireless communications at the network entity, among other possible benefits.

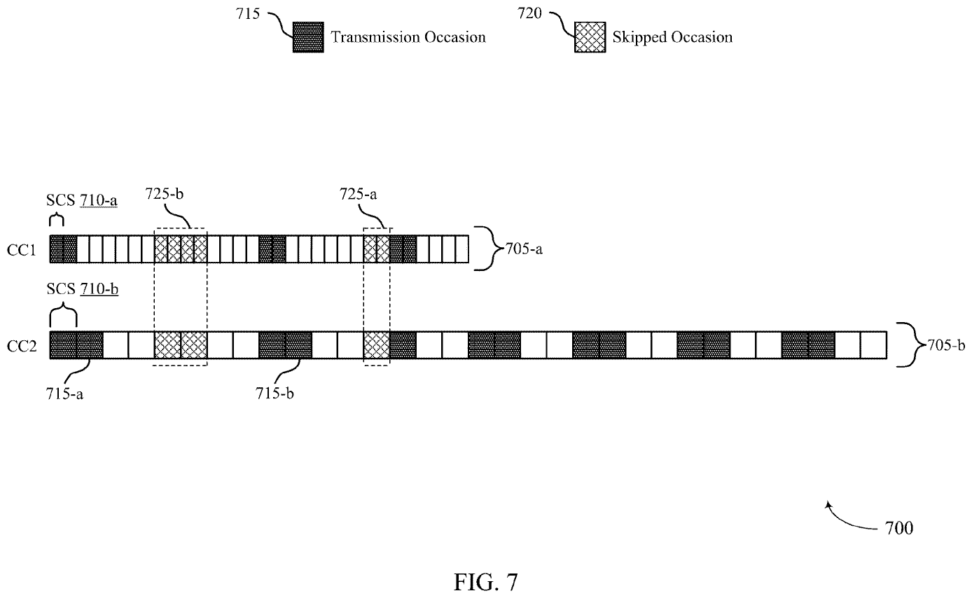

FIG. 7 illustrates an example of a component carrier diagram 700 that supports skipping indications for uplink configured grants in accordance with one or more aspects of the present disclosure. The component carrier diagram 700 may implement or be implemented to facilitate or realize one or more aspects of the wireless communications system 100, the wireless communications system 200, the configured grant diagrams 300, the skipping indication schemes 400, the skipping indication schemes 500, and the skipping indication schemes 600. For example, the component carrier diagram 700 may be implemented at a UE and a network entity, which may be an example of the corresponding devices illustrated by and described with reference to FIGS. 1, 2, 3A, 3B, 4A, 4B, 4C, 5A, 5B, 5C, 6A, and 6B.

The network entity may configure the UE with multiple configured grants. In some examples, the UE may support one or more techniques for indicating unused transmission occasions scheduled via one or more of the configured grants. For example, the UE may transmit UCI to the network entity that may include a skipping indication. The skipping indication may indicate one or more transmission occasions during which the UE may skip uplink transmissions. That is, the skipping indication may indicate one or more of the skipped occasions 720, which may correspond to one or more transmission occasions 715 during which the UE may skip uplink transmissions. In some examples, the skipping indication may indicate transmission occasions across multiple configured grants that may be associated with multiple (e.g., different) component carriers. For example, the network entity may transmit control signaling to the UE that indicates a first resource allocation for the PUSCH, which may include multiple time intervals on a first component carrier (CC1). The first resource allocation may be associated with a configured grant 705-a. The configured grant 705-a may schedule one or more transmission occasions 715 across the resource allocation on CC1. Additionally, the network entity may transmit control signaling to the UE that indicates a second resource allocation for the PUSCH, which may include multiple time intervals on a second component carrier (CC2). The second resource allocation may be associated with a configured grant 705-b. The configured grant 705-b may schedule one or more transmission occasions 715 across the resource allocation on CC2. As illustrated in the example of FIG. 7, CC1 and CC2 may be associated with multiple (e.g., different) subcarrier spacings (SCSs). That is, the first component carrier (CC1) may be associated with SCS 710-a and the second component carrier (CC2) may be associated with SCS 710-b. In other words, the UE may transmit CG-UCI carrying a skipping indication to indicate skipped occasions 720 (e.g., configured grant skippings) for multiple component carriers (e.g., CC1 and CC2) that may have multiple (e.g., different) SCSs.

In some examples, the skipped occasions 720 may occur within a quantity of time intervals (e.g., a quantity of slots or a quantity of symbols). For example, the UE may indicate a duration (L), which may correspond to a quantity of slots or a quantity of symbols during which the UE may skip uplink transmissions. In some examples, the UE may indicate a timing offset (S). In some other examples, the UE may be configured with a timing offset (X). In the example of FIG. 7, the timing offset (S or X) may correspond to two time intervals (e.g., two slots or two symbols). The UE may determine an SCS to use for determining time interval duration (e.g., a duration of a slot or a duration of a symbol) associated with the skipped occasions 720. That is, the skipped occasions may correspond to slots or symbols and the UE may scale the slot or symbol duration by an SCS value. In some examples, an SCS value used to determine (e.g., scale) the slot or symbol time duration may correspond to a default SCS value. That is, a default SCS value may be applied with the skipped occasions 720 (e.g., the configured grant skippings). For example, the default SCS value may correspond to a minimum SCS, a maximum SCS, or some other suitable SCS among component carriers associated with the multiple configured grants (e.g., among CC1 and CC2). In some other examples, the SCS value used to determine (e.g., scale) the slot or symbol duration may correspond to the component carrier used to transmit the UCI carrying the skipping indication (e.g., the CG-UCI).

For example, the UE may determine to skip uplink transmissions during a duration 725-a. In such an example, the UE may transmit UCI to the network entity during a transmission occasion 715-a. In the example of FIG. 7, the UE may be configured to scale the time interval duration associated with the skipped occasions 720 according to the SCS 710-b. For example, the UE may be configured to use a default SCS value that includes the SCS 710-b (e.g., a maximum SCS among the SCS 710-a and the SCS 710-b) or the UE may be configured to use the SCS of the component carrier in which the UCI carrying the skipping indication is transmitted. Accordingly, the UCI transmitted during the transmission occasion 715-a may carry a first skipping indication that indicates a duration of L=2. In some examples, the first skipping indication may include a first CG-ID (CG-ID1) that corresponds to the configured grant 705-a and indicates that the first skipping indication applies to the configured grant 705-a. Additionally, the first skipping indication may include a second CG-ID (CG-ID2) that corresponds to the configured grant 705-b and indicates that the first skipping indication applies to the configured grant 705-b. In such examples, the first skipping indication may indicate that the duration 725-a includes four of the skipped occasions 720 on the first component carrier (CC1) and two of the skipped occasions 720 on the second component carrier (CC2). Additionally, or alternatively, the UE may determine to skip uplink transmissions during a duration 725-b. In such an example, the UE may transmit UCI to the network entity during a transmission occasion 715-b. The UCI transmitted during the transmission occasion 715-b may carry a second skipping indication that indicates a duration of L=1. In some examples, the second skipping indication may include a first CG-ID (CG-ID1) that corresponds to the configured grant 705-a and indicates that the second skipping indication applies to the configured grant 705-a. Additionally, the second skipping indication may include a second CG-ID (CG-ID2) that corresponds to the configured grant 705-b and indicates that the second skipping indication applies to the configured grant 705-b. In such examples, the second skipping indication may indicate that the duration 725-b includes two of the skipped occasions 720 on the first component carrier (CC1) and one of the skipped occasion 720 on the second component carrier (CC2). In some examples, scaling the time interval duration based on a default SCS value or based on the SCS of the component carrier used to transmit the skipping indication may lead to increased capacity and improved resource utilization for wireless communications at the network entity, among other possible benefits.

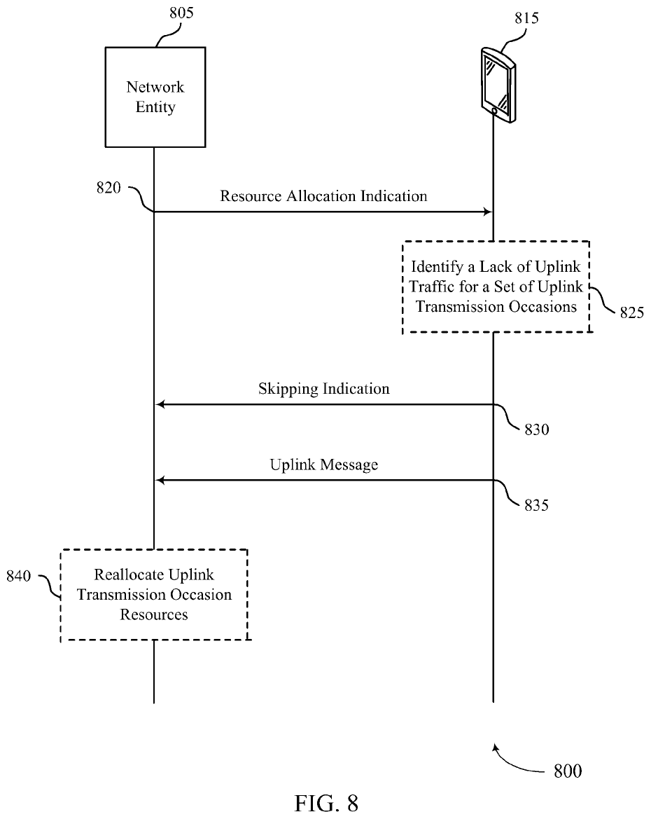

FIG. 8 illustrates an example of a process flow 800 that supports skipping indications for uplink configured grants in accordance with one or more aspects of the present disclosure. The process flow 800 may implement or be implemented to facilitate or realize one or more aspects of the wireless communications system 100, the wireless communications system 200, the configured grant diagrams 300, the skipping indication schemes 400, the skipping indication schemes 500, the skipping indication schemes 600, and the component carrier diagram 700. For example, the process flow 800 may be implemented at a UE 815 and a network entity 805, which may be an example of the corresponding devices illustrated by and described with reference to FIGS. 1, 2, 3A, 3B, 4A, 4B, 4C, 5A, 5B, 5C, 6A, 6B, and 7. The operations performed at the UE 815 and the network entity 805 may support improvements to communications between the UE 815 and the network entity 805, among other possible benefits. In the following description of the process flow 800, the operations performed at the UE 815 and the network entity 805 may occur in a different order than the example order shown. Additionally, the operations performed at the UE 815 and the network entity 805 may be performed at different times. Some operations may be combined and some operations may be omitted. In some examples, the UE 815 and the network entity 805 may support a framework for indicating configured grant transmission occasions during which the UE 815 may skip uplink transmissions.

At 820, the UE 815 may receive a resource allocation indication from the network entity 805. The resource allocation indication may be an example of a resource allocation indication illustrated by and described with reference to FIG. 2. For example, the resource allocation indication may indicate multiple uplink resource allocations to the UE 815. In some examples, the multiple uplink resource allocations may be associated with multiple configured grants that schedule multiple uplink transmission occasions for the UE 815 across the multiple uplink resource allocations on one or more component carriers.

In some examples, at 825, the UE 815 may identify a lack of uplink traffic for a set of uplink transmission occasions of the multiple uplink transmission occasions. For example, the UE 815 may identify a lack of periodic uplink traffic associated with an XR application. In such examples, the UE 815 may refrain from transmitting uplink traffic during the set of uplink transmission occasions. That is, the UE may skip uplink transmission during the set of uplink transmission occasions, such that the set of uplink transmission occasions may be unused.

At 830, the UE may transmit a skipping indication to the network entity. The skipping indication may be an example of a skipping indication illustrated by and described with reference to FIGS. 2, 3A, 3B, 4A, 4B, 4C, 5A, 5B, 5C, 6A, 6B, and 7. For example, the skipping may indicate the set of uplink transmission occasions during which the UE skips uplink transmissions (e.g., due to the lack of uplink traffic). In some examples, the UE 815 may transmit the skipping indication via UCI. In some other examples, the UE 815 may transmit the skipping indication via a MAC-CE.

In some examples, the UE 815 may determine that one or more uplink transmission occasions during which the UE may skip uplink transmissions overlap in time. For example, the UE 815 may transmit UCI (e.g., a CG-UCI) carrying the skipping indication to indicate configured grant skippings for a quantity of configured grant occasions (e.g., the set of uplink transmission occasions) and a portion (Y) of the quantity of configured grant occasions may overlap in time. In such an example, the UE 815 may count each overlapping uplink transmission occasion of the portion (Y) of overlapping uplink transmission occasions as a single uplink transmission occasion (e.g., within the set of uplink transmission occasion). In other words, two or more uplink transmission occasion of the set of uplink transmission occasions may be overlapping in time. In some other examples, the UE 815 may count uplink transmissions that overlap in time as a single uplink transmission occasion (e.g., within the set of uplink transmission occasions). In other words, an uplink transmission occasion of the set of uplink transmission occasions may correspond to two uplink transmission occasions that are overlapping in time.

At 835, the UE 815 may transmit an uplink message to the network entity 805. In some examples, the UE 815 may transmit the uplink message in accordance with the multiple configured grants and the UCI. For example, the UE 815 may use a transmission occasion that may be unassociated with the skipping indication to transmit the uplink message.

In some examples, at 840, the network entity may reallocate uplink transmission occasion resources associated with the set of uplink transmission occasions based on the skipping indication. For example, the network entity may schedule communications for one or more other UEs on one or more resources that occur during the set of uplink transmission occasions. In some examples, by reallocating the uplink transmission resources to other UEs, the network entity 805 may increase capacity and resource utilization, among other possible benefits.

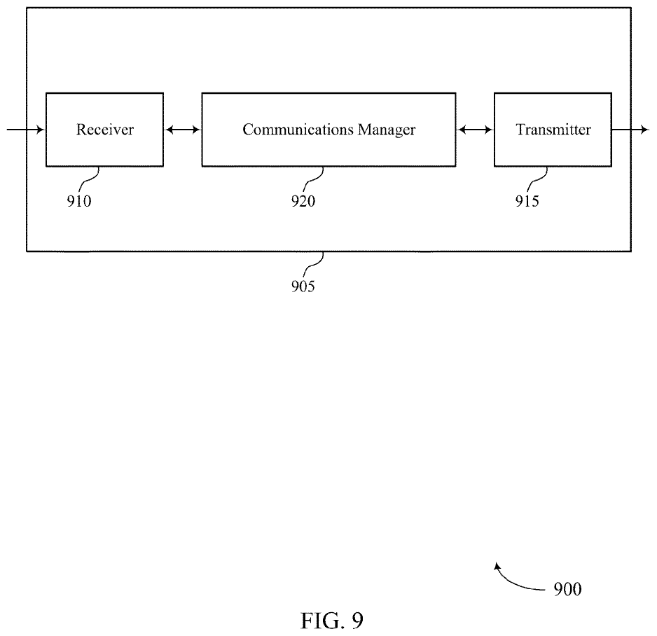

FIG. 9 illustrates a block diagram 900 of a device 905 that supports skipping indications for uplink configured grants in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to skipping indications for uplink configured grants). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to skipping indications for uplink configured grants). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of skipping indications for uplink configured grants as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE (e.g., the device 905) in accordance with examples as disclosed herein. For example, the communications manager 920 may be configured as or otherwise support a means for receiving, from a network entity, a set of multiple indications of a set of multiple uplink resource allocations, where the set of multiple uplink resource allocations are associated with a set of multiple configured grants that schedule a set of multiple uplink transmission occasions for the UE across the set of multiple uplink resource allocations on one or more component carriers. The communications manager 920 may be configured as or otherwise support a means for transmitting, to the network entity, UCI that indicates a set of uplink transmission occasions from the set of multiple uplink transmission occasions during which the UE skips uplink transmissions. The communications manager 920 may be configured as or otherwise support a means for transmitting, to the network entity, an uplink message in accordance with the set of multiple configured grants and the UCI.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources.

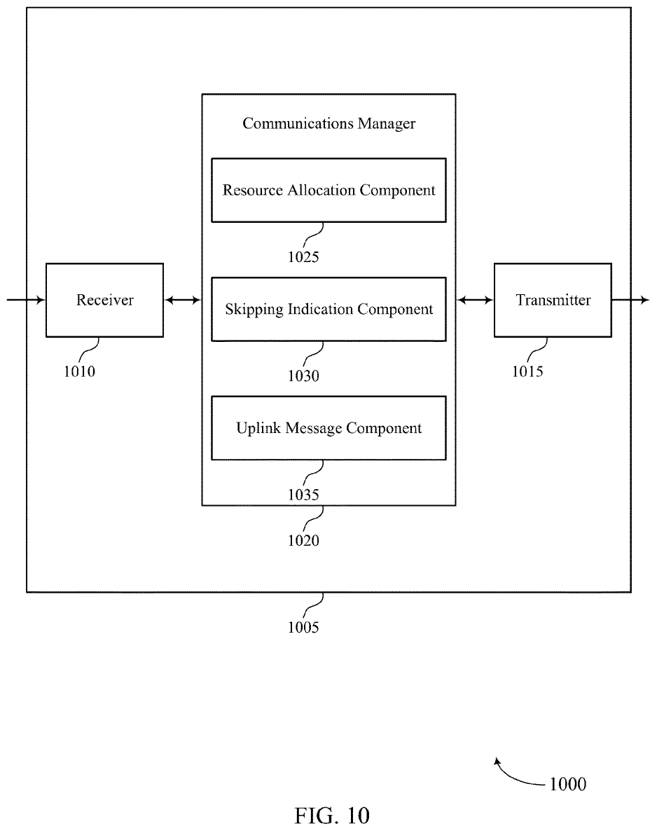

FIG. 10 illustrates a block diagram 1000 of a device 1005 that supports skipping indications for uplink configured grants in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to skipping indications for uplink configured grants). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to skipping indications for uplink configured grants). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of skipping indications for uplink configured grants as described herein. For example, the communications manager 1020 may include a resource allocation component 1025, a skipping indication component 1030, an uplink message component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE (e.g., the device 1005) in accordance with examples as disclosed herein. The resource allocation component 1025 may be configured as or otherwise support a means for receiving, from a network entity, a set of multiple indications of a set of multiple uplink resource allocations, where the set of multiple uplink resource allocations are associated with a set of multiple configured grants that schedule a set of multiple uplink transmission occasions for the UE across the set of multiple uplink resource allocations on one or more component carriers. The skipping indication component 1030 may be configured as or otherwise support a means for transmitting, to the network entity, UCI that indicates a set of uplink transmission occasions from the set of multiple uplink transmission occasions during which the UE skips uplink transmissions. The uplink message component 1035 may be configured as or otherwise support a means for transmitting, to the network entity, an uplink message in accordance with the set of multiple configured grants and the UCI.

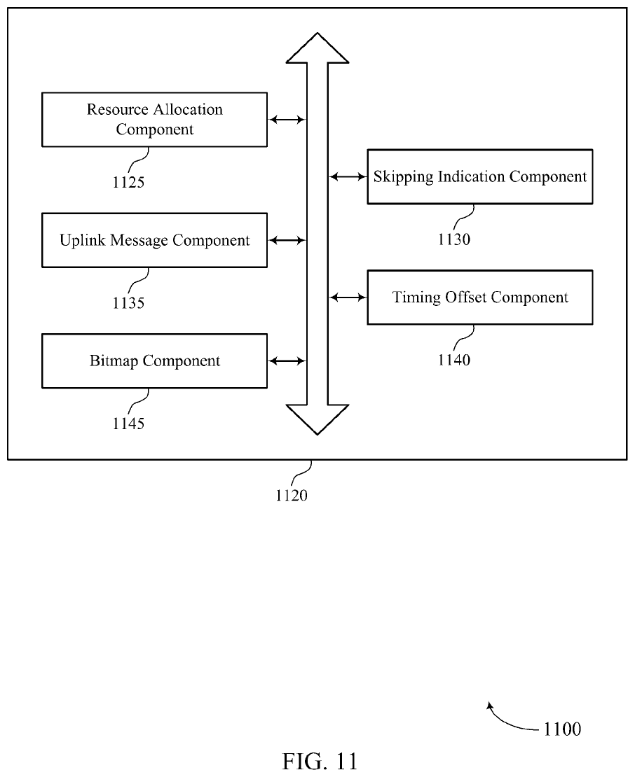

FIG. 11 illustrates a block diagram 1100 of a communications manager 1120 that supports skipping indications for uplink configured grants in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of skipping indications for uplink configured grants as described herein. For example, the communications manager 1120 may include a resource allocation component 1125, a skipping indication component 1130, an uplink message component 1135, a timing offset component 1140, a bitmap component 1145, or any combination thereof. Each of these components may communicate, directly or indirectly, with one another (e.g., via one or more buses).

The communications manager 1120 may support wireless communication at a UE in accordance with examples as disclosed herein. The resource allocation component 1125 may be configured as or otherwise support a means for receiving, from a network entity, a set of multiple indications of a set of multiple uplink resource allocations, where the set of multiple uplink resource allocations are associated with a set of multiple configured grants that schedule a set of multiple uplink transmission occasions for the UE across the set of multiple uplink resource allocations on one or more component carriers. The skipping indication component 1130 may be configured as or otherwise support a means for transmitting, to the network entity, UCI that indicates a set of uplink transmission occasions from the set of multiple uplink transmission occasions during which the UE skips uplink transmissions. The uplink message component 1135 may be configured as or otherwise support a means for transmitting, to the network entity, an uplink message in accordance with the set of multiple configured grants and the UCI.

In some examples, to support transmitting the UCI, the skipping indication component 1130 may be configured as or otherwise support a means for transmitting the UCI during an uplink transmission occasion of the set of multiple uplink transmission occasions and on a component carrier of the one or more component carriers, where the uplink transmission occasion is scheduled via a configured grant of the set of multiple configured grants, and where the set of uplink transmission occasions occur subsequent to the uplink transmission occasion.

In some examples, the set of uplink transmission occasions includes one or more uplink transmission occasions that are scheduled via the configured grant. Additionally, or alternatively, the set of uplink transmission occasions includes one or more uplink transmission occasions on the component carrier.

In some examples, the set of uplink transmission occasions includes a first one or more uplink transmission occasions that are scheduled via the configured grant and a second one or more other uplink transmission occasions that are scheduled via a second configured grant of the set of multiple configured grants. In some examples, the configured grant and the second configured grant are associated with different component carriers.

In some examples, transmitting the UCI during the uplink transmission occasion scheduled via the configured grant indicates that the set of uplink transmission occasions is associated with at least the configured grant. Additionally, or alternatively, transmitting the UCI on the component carrier indicates that the set of uplink transmission occasions is associated with at least the component carrier.

In some examples, the UCI includes at least one CG-ID that indicates at least one configured grant of the set of multiple configured grants that is associated with the set of uplink transmission occasions. Additionally, or alternatively, the UCI includes at least one component carrier index that indicates at least one component carrier of the one or more component carriers that is associated with the set of uplink transmission occasions.

In some examples, the UCI indicates a duration during which the UE skips uplink transmissions. In some examples, the set of uplink transmission occasions occur during the duration and. In some examples, the duration is associated with a timing offset. In some examples, the UCI indicates the timing offset associated with the duration.

In some examples, the timing offset component 1140 may be configured as or otherwise support a means for receiving, from the network entity, an indication of the timing offset associated with the duration. In some examples, the duration includes a quantity of slots or symbols, a quantity of uplink transmission occasions, a quantity of time units, or any combination thereof. In some examples, the timing offset includes a quantity of consecutive slots or symbols, a quantity of consecutive uplink transmission occasions, a quantity of time units, or any combination thereof.

In some examples, the duration includes a quantity of time periods. In some examples, a time period is based on a periodicity associated with a configured grant of the set of multiple configured grants that was used to schedule a respective uplink transmission occasion of the set of uplink transmission occasions.

In some examples, the timing offset includes a quantity of time periods. In some examples, a time period is based on a periodicity associated with a configured grant of the set of multiple configured grants that was used to schedule a respective uplink transmission occasion of the set of uplink transmission occasions.

In some examples, the UCI includes a bitmap that indicates a set of multiple durations during which the UE skips uplink transmissions. In some examples, the set of uplink transmission occasions occur across the set of multiple durations.

In some examples, the bitmap component 1145 may be configured as or otherwise support a means for receiving, from the network entity, an indication of a quantity of bits associated with the bitmap, where a temporal length associated with each duration of the set of multiple durations is based on the quantity of bits.

In some examples, the set of uplink transmission occasions occur during a duration associated with a default subcarrier spacing. In some examples, the set of uplink transmission occasions occur during a duration associated with a subcarrier spacing that is based on a component carrier used for transmission of the UCI.

In some examples, an uplink transmission occasion of the set of uplink transmission occasions correspond to two uplink transmission occasions that are overlapping in time. In some examples, two or more uplink transmission occasion of the set of uplink transmission occasions are overlapping in time.

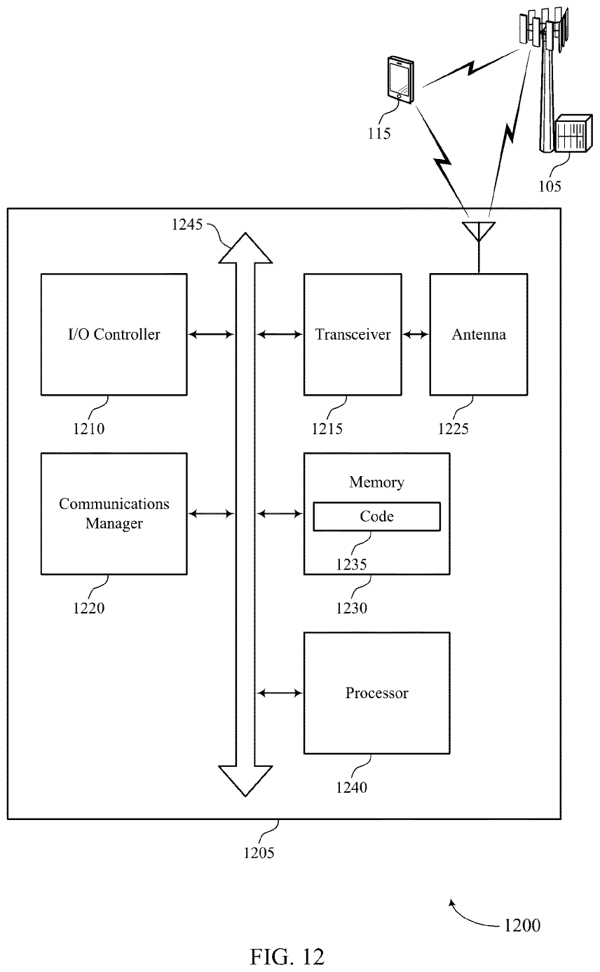

FIG. 12 illustrates a diagram of a system 1200 including a device 1205 that supports skipping indications for uplink configured grants in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting skipping indications for uplink configured grants). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a UE (e.g., the device 1205) in accordance with examples as disclosed herein. For example, the communications manager 1220 may be configured as or otherwise support a means for receiving, from a network entity, a set of multiple indications of a set of multiple uplink resource allocations, where the set of multiple uplink resource allocations are associated with a set of multiple configured grants that schedule a set of multiple uplink transmission occasions for the UE across the set of multiple uplink resource allocations on one or more component carriers. The communications manager 1220 may be configured as or otherwise support a means for transmitting, to the network entity, UCI that indicates a set of uplink transmission occasions from the set of multiple uplink transmission occasions during which the UE skips uplink transmissions. The communications manager 1220 may be configured as or otherwise support a means for transmitting, to the network entity, an uplink message in accordance with the set of multiple configured grants and the UCI.

By including or configuring the communications manager 1220 in accordance with examples as described herein, the device 1205 may support techniques for reduced latency, more efficient utilization of communication resources, and improved coordination between devices.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of skipping indications for uplink configured grants as described herein, or the processor 1240 and the memory 1230 may be otherwise configured to perform or support such operations.

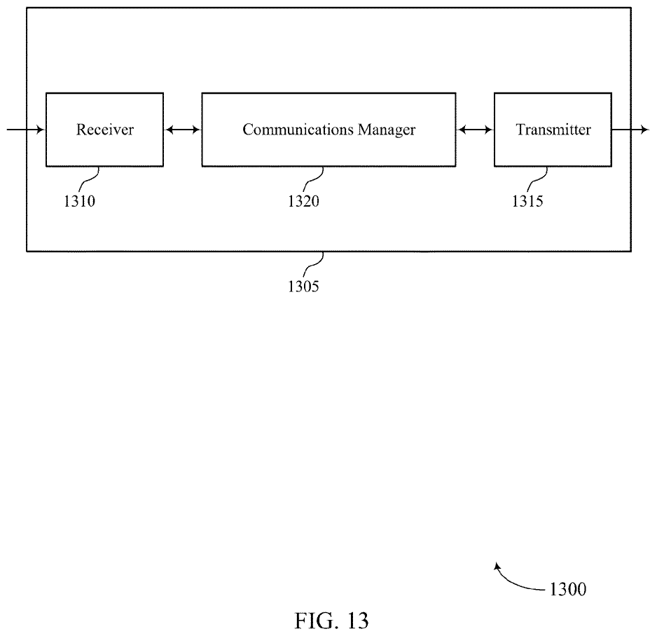

FIG. 13 illustrates a block diagram 1300 of a device 1305 that supports skipping indications for uplink configured grants in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of skipping indications for uplink configured grants as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity (e.g., the device 1305) in accordance with examples as disclosed herein. For example, the communications manager 1320 may be configured as or otherwise support a means for outputting a set of multiple indications of a set of multiple uplink resource allocations, where the set of multiple uplink resource allocations are associated with a set of multiple configured grants that schedule a set of multiple uplink transmission occasions for a UE across the set of multiple uplink resource allocations on one or more component carriers. The communications manager 1320 may be configured as or otherwise support a means for obtaining UCI that indicates a set of uplink transmission occasions from the set of multiple uplink transmission occasions during which the UE skips uplink transmissions. The communications manager 1320 may be configured as or otherwise support a means for obtaining an uplink message in accordance with the set of multiple configured grants and the UCI.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for more efficient utilization of communication resources.

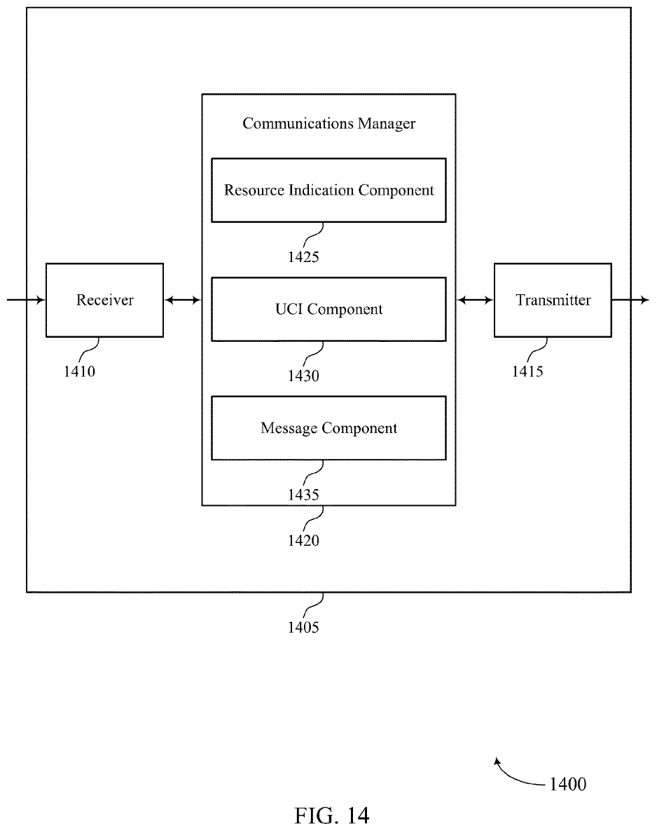

FIG. 14 illustrates a block diagram 1400 of a device 1405 that supports skipping indications for uplink configured grants in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of skipping indications for uplink configured grants as described herein. For example, the communications manager 1420 may include a resource indication component 1425, a UCI component 1430, a message component 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a network entity (e.g., the device 1405) in accordance with examples as disclosed herein. The resource indication component 1425 may be configured as or otherwise support a means for outputting a set of multiple indications of a set of multiple uplink resource allocations, where the set of multiple uplink resource allocations are associated with a set of multiple configured grants that schedule a set of multiple uplink transmission occasions for a UE across the set of multiple uplink resource allocations on one or more component carriers. The UCI component 1430 may be configured as or otherwise support a means for obtaining UCI that indicates a set of uplink transmission occasions from the set of multiple uplink transmission occasions during which the UE skips uplink transmissions. The message component 1435 may be configured as or otherwise support a means for obtaining an uplink message in accordance with the set of multiple configured grants and the UCI.

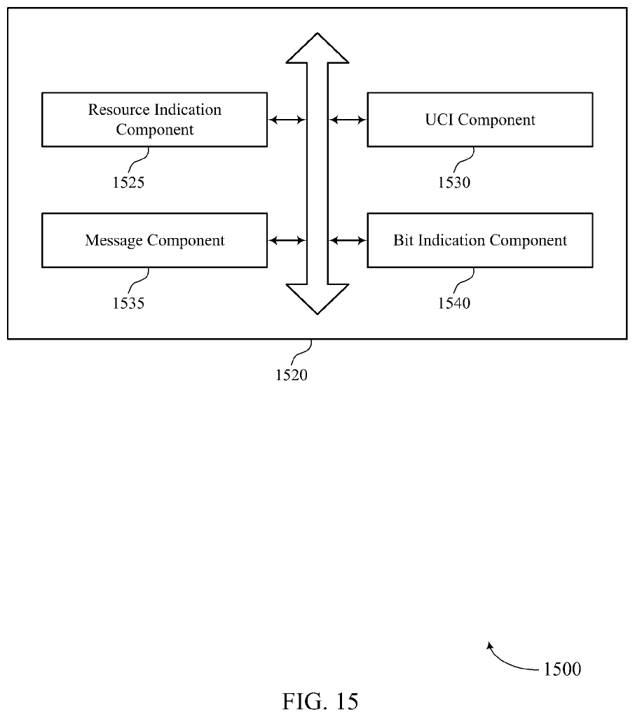

FIG. 15 illustrates a block diagram 1500 of a communications manager 1520 that supports skipping indications for uplink configured grants in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of skipping indications for uplink configured grants as described herein. For example, the communications manager 1520 may include a resource indication component 1525, a UCI component 1530, a message component 1535, a bit indication component 1540, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communication at a network entity in accordance with examples as disclosed herein. The resource indication component 1525 may be configured as or otherwise support a means for outputting a set of multiple indications of a set of multiple uplink resource allocations, where the set of multiple uplink resource allocations are associated with a set of multiple configured grants that schedule a set of multiple uplink transmission occasions for a UE across the set of multiple uplink resource allocations on one or more component carriers. The UCI component 1530 may be configured as or otherwise support a means for obtaining UCI that indicates a set of uplink transmission occasions from the set of multiple uplink transmission occasions during which the UE skips uplink transmissions. The message component 1535 may be configured as or otherwise support a means for obtaining an uplink message in accordance with the set of multiple configured grants and the UCI.

In some examples, to support transmitting the UCI, the UCI component 1530 may be configured as or otherwise support a means for obtaining the UCI during an uplink transmission occasion of the set of multiple uplink transmission occasions and on a component carrier of the one or more component carriers, where the uplink transmission occasion is scheduled via a configured grant of the set of multiple configured grants, and where the set of uplink transmission occasions occur subsequent to the uplink transmission occasion.

In some examples, the UCI includes at least one CG-ID that indicates at least one configured grant of the set of multiple configured grants that is associated with the set of uplink transmission occasions and indicates at least one component carrier index that indicates at least one component carrier of the one or more component carriers that is associated with the set of uplink transmission occasions.

In some examples, the UCI indicates a duration during which the UE skips uplink transmissions. In some examples, the set of uplink transmission occasions occur during the duration and. In some examples, the duration is associated with a timing offset. In some examples, the UCI includes a bitmap that indicates a set of multiple durations during which the UE skips uplink transmissions. In some examples, the set of uplink transmission occasions occur across the set of multiple durations.

In some examples, the bit indication component 1540 may be configured as or otherwise support a means for receiving, from the network entity, an indication of a quantity of bits associated with the bitmap, where a temporal length associated with each duration of the set of multiple durations is based on the quantity of bits.

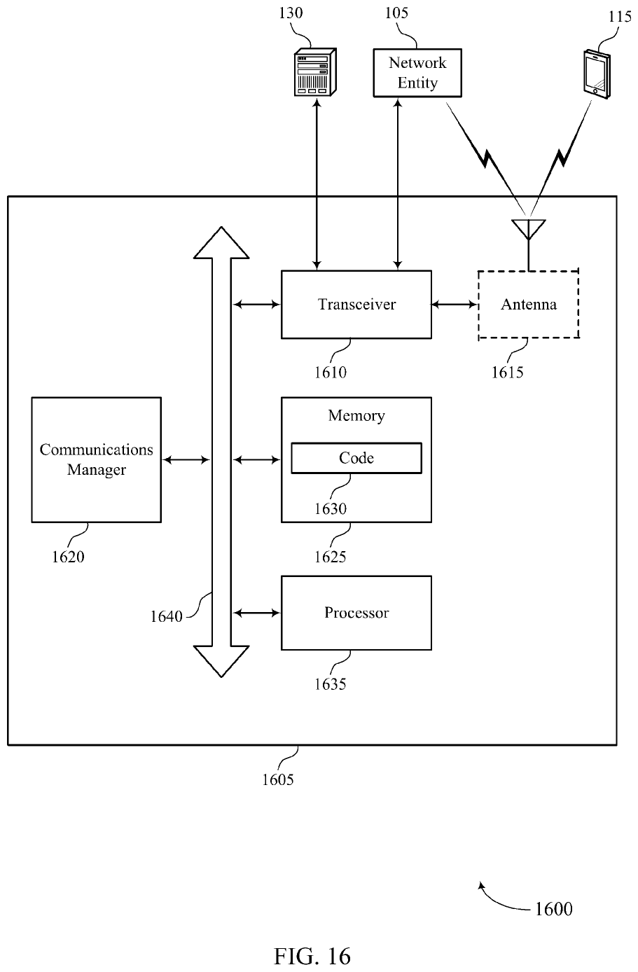

FIG. 16 illustrates a diagram of a system 1600 including a device 1605 that supports skipping indications for uplink configured grants in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or memory components (for example, the processor 1635, or the memory 1625, or both), may be included in a chip or chip assembly that is installed in the device 1605. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting skipping indications for uplink configured grants). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605. The processor 1635 may be any one or more suitable processors capable of executing scripts or instructions of one or more software programs stored in the device 1605 (such as within the memory 1625). In some implementations, the processor 1635 may be a component of a processing system. A processing system may generally refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the processor 1635, or the transceiver 1610, or the communications manager 1620, or other components or combinations of components of the device 1605. The processing system of the device 1605 may interface with other components of the device 1605, and may process information received from other components (such as inputs or signals) or output information to other components. For example, a chip or modem of the device 1605 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1605 may transmit information output from the chip or modem. Additionally, or alternatively, in some implementations, the one or more interfaces may refer to an interface between the processing system of the chip or modem and a receiver, such that the device 1605 may obtain information or signal inputs, and the information may be passed to the processing system. A person having ordinary skill in the art will readily recognize that a first interface also may obtain information or signal inputs, and a second interface also may output information or signal outputs.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communication at a network entity (e.g., the device 1605) in accordance with examples as disclosed herein. For example, the communications manager 1620 may be configured as or otherwise support a means for outputting a set of multiple indications of a set of multiple uplink resource allocations, where the set of multiple uplink resource allocations are associated with a set of multiple configured grants that schedule a set of multiple uplink transmission occasions for a UE across the set of multiple uplink resource allocations on one or more component carriers. The communications manager 1620 may be configured as or otherwise support a means for obtaining UCI that indicates a set of uplink transmission occasions from the set of multiple uplink transmission occasions during which the UE skips uplink transmissions. The communications manager 1620 may be configured as or otherwise support a means for obtaining an uplink message in accordance with the set of multiple configured grants and the UCI.

By including or configuring the communications manager 1620 in accordance with examples as described herein, the device 1605 may support techniques for improved communication reliability, reduced latency, more efficient utilization of communication resources, and improved coordination between devices.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, the processor 1635, the memory 1625, the code 1630, or any combination thereof. For example, the code 1630 may include instructions executable by the processor 1635 to cause the device 1605 to perform various aspects of skipping indications for uplink configured grants as described herein, or the processor 1635 and the memory 1625 may be otherwise configured to perform or support such operations.

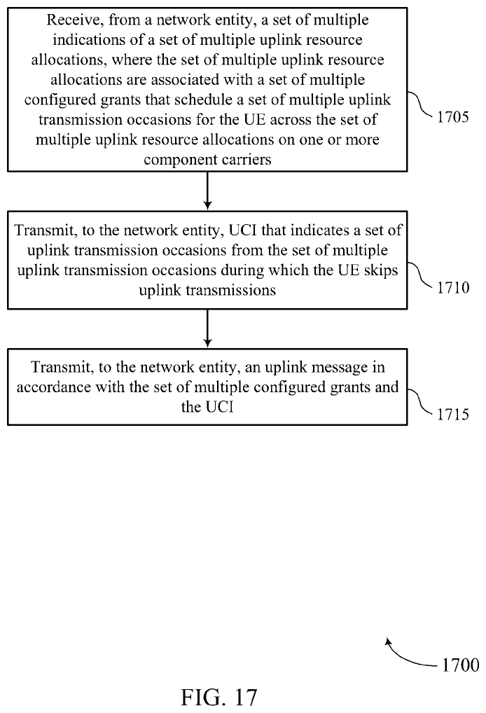

FIG. 17 illustrates a flowchart showing a method 1700 that supports skipping indications for uplink configured grants in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, a set of multiple indications of a set of multiple uplink resource allocations, where the set of multiple uplink resource allocations are associated with a set of multiple configured grants that schedule a set of multiple uplink transmission occasions for the UE across the set of multiple uplink resource allocations on one or more component carriers. The operations of 1705 may be performed in accordance with examples as disclosed herein. In some examples, aspects of the operations of 1705 may be performed by a resource allocation component 1125 as described with reference to FIG. 11.

At 1710, the method may include transmitting, to the network entity, UCI that indicates a set of uplink transmission occasions from the set of multiple uplink transmission occasions during which the UE skips uplink transmissions. The operations of 1710 may be performed in accordance with examples as disclosed herein. In some examples, aspects of the operations of 1710 may be performed by a skipping indication component 1130 as described with reference to FIG. 11.

At 1715, the method may include transmitting, to the network entity, an uplink message in accordance with the set of multiple configured grants and the UCI. The operations of 1715 may be performed in accordance with examples as disclosed herein. In some examples, aspects of the operations of 1715 may be performed by an uplink message component 1135 as described with reference to FIG. 11.

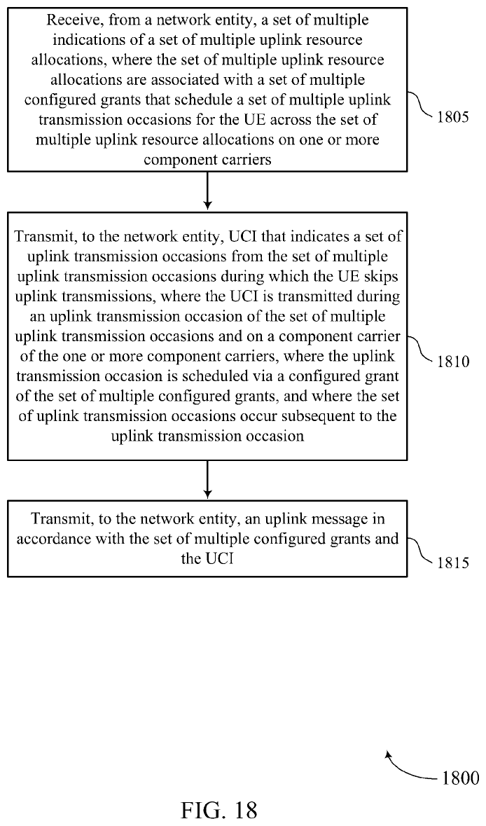

FIG. 18 illustrates a flowchart showing a method 1800 that supports skipping indications for uplink configured grants in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving, from a network entity, a set of multiple indications of a set of multiple uplink resource allocations, where the set of multiple uplink resource allocations are associated with a set of multiple configured grants that schedule a set of multiple uplink transmission occasions for the UE across the set of multiple uplink resource allocations on one or more component carriers. The operations of 1805 may be performed in accordance with examples as disclosed herein. In some examples, aspects of the operations of 1805 may be performed by a resource allocation component 1125 as described with reference to FIG. 11.

At 1810, the method may include transmitting, to the network entity, UCI that indicates a set of uplink transmission occasions from the set of multiple uplink transmission occasions during which the UE skips uplink transmissions, where the UCI is transmitted during an uplink transmission occasion of the set of multiple uplink transmission occasions and on a component carrier of the one or more component carriers, where the uplink transmission occasion is scheduled via a configured grant of the set of multiple configured grants, and where the set of uplink transmission occasions occur subsequent to the uplink transmission occasion. The operations of 1810 may be performed in accordance with examples as disclosed herein. In some examples, aspects of the operations of 1810 may be performed by a skipping indication component 1130 as described with reference to FIG. 11.

At 1815, the method may include transmitting, to the network entity, an uplink message in accordance with the set of multiple configured grants and the UCI. The operations of 1815 may be performed in accordance with examples as disclosed herein. In some examples, aspects of the operations of 1815 may be performed by an uplink message component 1135 as described with reference to FIG. 11.

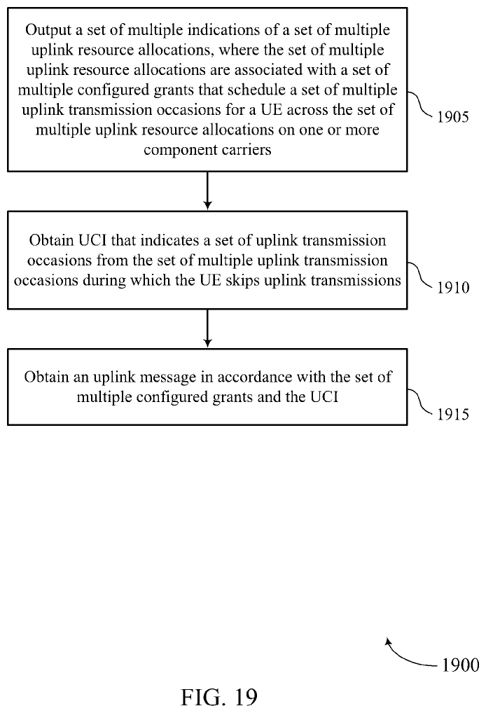

FIG. 19 illustrates a flowchart showing a method 1900 that supports skipping indications for uplink configured grants in accordance with one or more aspects of the present disclosure. The operations of the method 1900 may be implemented by a network entity or its components as described herein. For example, the operations of the method 1900 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1905, the method may include outputting a set of multiple indications of a set of multiple uplink resource allocations, where the set of multiple uplink resource allocations are associated with a set of multiple configured grants that schedule a set of multiple uplink transmission occasions for a UE across the set of multiple uplink resource allocations on one or more component carriers. The operations of 1905 may be performed in accordance with examples as disclosed herein. In some examples, aspects of the operations of 1905 may be performed by a resource indication component 1525 as described with reference to FIG. 15.

At 1910, the method may include obtaining UCI that indicates a set of uplink transmission occasions from the set of multiple uplink transmission occasions during which the UE skips uplink transmissions. The operations of 1910 may be performed in accordance with examples as disclosed herein. In some examples, aspects of the operations of 1910 may be performed by a UCI component 1530 as described with reference to FIG. 15.

At 1915, the method may include obtaining an uplink message in accordance with the set of multiple configured grants and the UCI. The operations of 1915 may be performed in accordance with examples as disclosed herein. In some examples, aspects of the operations of 1915 may be performed by a message component 1535 as described with reference to FIG. 15.

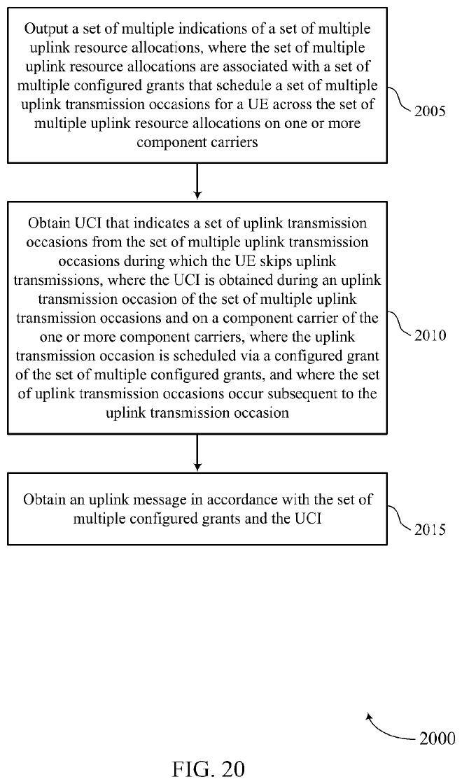

FIG. 20 illustrates a flowchart showing a method 2000 that supports skipping indications for uplink configured grants in accordance with one or more aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include outputting a set of multiple indications of a set of multiple uplink resource allocations, where the set of multiple uplink resource allocations are associated with a set of multiple configured grants that schedule a set of multiple uplink transmission occasions for a UE across the set of multiple uplink resource allocations on one or more component carriers. The operations of 2005 may be performed in accordance with examples as disclosed herein. In some examples, aspects of the operations of 2005 may be performed by a resource indication component 1525 as described with reference to FIG. 15.

At 2010, the method may include obtaining UCI that indicates a set of uplink transmission occasions from the set of multiple uplink transmission occasions during which the UE skips uplink transmissions, where the UCI is obtained during an uplink transmission occasion of the set of multiple uplink transmission occasions and on a component carrier of the one or more component carriers, where the uplink transmission occasion is scheduled via a configured grant of the set of multiple configured grants, and where the set of uplink transmission occasions occur subsequent to the uplink transmission occasion. The operations of 2010 may be performed in accordance with examples as disclosed herein. In some examples, aspects of the operations of 2010 may be performed by a UCI component 1530 as described with reference to FIG. 15.

At 2015, the method may include obtaining an uplink message in accordance with the set of multiple configured grants and the UCI. The operations of 2015 may be performed in accordance with examples as disclosed herein. In some examples, aspects of the operations of 2015 may be performed by a message component 1535 as described with reference to FIG. 15.

The following provides an overview of aspects of the present disclosure:

Aspect 1: A method for wireless communication at a UE, comprising: receiving, from a network entity, a plurality of indications of a plurality of uplink resource allocations, wherein the plurality of uplink resource allocations are associated with a plurality of configured grants that schedule a plurality of uplink transmission occasions for the UE across the plurality of uplink resource allocations on one or more component carriers; transmitting, to the network entity, UCI that indicates a set of uplink transmission occasions from the plurality of uplink transmission occasions during which the UE skips uplink transmissions; and transmitting, to the network entity, an uplink message in accordance with the plurality of configured grants and the UCI.

Aspect 2: The method of aspect 1, wherein transmitting the UCI comprises: transmitting the UCI during an uplink transmission occasion of the plurality of uplink transmission occasions and on a component carrier of the one or more component carriers, wherein the uplink transmission occasion is scheduled via a configured grant of the plurality of configured grants, and wherein the set of uplink transmission occasions occur subsequent to the uplink transmission occasion.

Aspect 3: The method of aspect 2, wherein the set of uplink transmission occasions comprises one or more uplink transmission occasions that are scheduled via the configured grant.

Aspect 4: The method of aspect 2, wherein the set of uplink transmission occasions comprises one or more uplink transmission occasions on the component carrier.

Aspect 5: The method of aspect 2, wherein the set of uplink transmission occasions comprises a first one or more uplink transmission occasions that are scheduled via the configured grant and a second one or more other uplink transmission occasions that are scheduled via a second configured grant of the plurality of configured grants, and the configured grant and the second configured grant are associated with different component carriers.

Aspect 6: The method of any of aspects 2 through 5, wherein transmitting the UCI during the uplink transmission occasion scheduled via the configured grant indicates that the set of uplink transmission occasions is associated with at least the configured grant.

Aspect 7: The method of any of aspects 2 through 5, wherein transmitting the UCI on the component carrier indicates that the set of uplink transmission occasions is associated with at least the component carrier.

Aspect 8: The method of any of aspects 2 through 5, wherein the UCI comprises at least one configured grant identifier that indicates at least one configured grant of the plurality of configured grants that is associated with the set of uplink transmission occasions.

Aspect 9: The method of any of aspects 2 through 5 and 8, wherein the UCI comprises at least one component carrier index that indicates at least one component carrier of the one or more component carriers that is associated with the set of uplink transmission occasions.

Aspect 10: The method of any of aspects 1 through 9, wherein the UCI indicates a duration during which the UE skips uplink transmissions, the set of uplink transmission occasions occur during the duration and the duration is associated with a timing offset.

Aspect 11: The method of aspect 10, wherein the UCI indicates the timing offset associated with the duration.

Aspect 12: The method of aspect 10, further comprising: receiving, from the network entity, an indication of the timing offset associated with the duration.

Aspect 13: The method of any of aspects 10 through 12, wherein the duration comprises a quantity of slots or symbols, a quantity of uplink transmission occasions, a quantity of time units, or any combination thereof.

Aspect 14: The method of any of aspects 10 through 13, wherein the timing offset comprises a quantity of consecutive slots or symbols, a quantity of consecutive uplink transmission occasions, a quantity of time units, or any combination thereof.

Aspect 15: The method of any of aspects 10 through 12, wherein the duration comprises a quantity of time periods, and a time period is based at least in part on a periodicity associated with a configured grant of the plurality of configured grants that was used to schedule a respective uplink transmission occasion of the set of uplink transmission occasions.

Aspect 16: The method of any of aspects 10 through 12 and 15, wherein the timing offset comprises a quantity of time periods, and a time period is based at least in part on a periodicity associated with a configured grant of the plurality of configured grants that was used to schedule a respective uplink transmission occasion of the set of uplink transmission occasions.

Aspect 17: The method of any of aspects 1 through 9, wherein the UCI comprises a bitmap that indicates a plurality of durations during which the UE skips uplink transmissions, and the set of uplink transmission occasions occur across the plurality of durations.

Aspect 18: The method of aspect 17, further comprising: receiving, from the network entity, an indication of a quantity of bits associated with the bitmap, wherein a temporal length associated with each duration of the plurality of durations is based at least in part on the quantity of bits.

Aspect 19: The method of any of aspects 1 through 18, wherein the set of uplink transmission occasions occur during a duration associated with a default subcarrier spacing.

Aspect 20: The method of any of aspects 1 through 18, wherein the set of uplink transmission occasions occur during a duration associated with a subcarrier spacing that is based at least in part on a component carrier used for transmission of the UCI.

Aspect 21: The method of any of aspects 1 through 20, wherein an uplink transmission occasion of the set of uplink transmission occasions correspond to two uplink transmission occasions that are overlapping in time.

Aspect 22: The method of any of aspects 1 through 20, wherein two or more uplink transmission occasion of the set of uplink transmission occasions are overlapping in time.

Aspect 23: A method for wireless communication at a network entity, comprising: outputting a plurality of indications of a plurality of uplink resource allocations, wherein the plurality of uplink resource allocations are associated with a plurality of configured grants that schedule a plurality of uplink transmission occasions for a UE across the plurality of uplink resource allocations on one or more component carriers; obtaining UCI that indicates a set of uplink transmission occasions from the plurality of uplink transmission occasions during which the UE skips uplink transmissions; and obtaining an uplink message in accordance with the plurality of configured grants and the UCI.

Aspect 24: The method of aspect 23, wherein transmitting the UCI comprises: obtaining the UCI during an uplink transmission occasion of the plurality of uplink transmission occasions and on a component carrier of the one or more component carriers, wherein the uplink transmission occasion is scheduled via a configured grant of the plurality of configured grants, and wherein the set of uplink transmission occasions occur subsequent to the uplink transmission occasion.

Aspect 25: The method of any of aspects 23 through 24, wherein the UCI comprises at least one configured grant identifier that indicates at least one configured grant of the plurality of configured grants that is associated with the set of uplink transmission occasions and indicates at least one component carrier index that indicates at least one component carrier of the one or more component carriers that is associated with the set of uplink transmission occasions.

Aspect 26: The method of any of aspects 23 through 25, wherein the UCI indicates a duration during which the UE skips uplink transmissions, the set of uplink transmission occasions occur during the duration and the duration is associated with a timing offset.

Aspect 27: The method of any of aspects 23 through 25, wherein the UCI comprises a bitmap that indicates a plurality of durations during which the UE skips uplink transmissions, and the set of uplink transmission occasions occur across the plurality of durations.

Aspect 28: The method of aspect 27, further comprising: receiving, from the network entity, an indication of a quantity of bits associated with the bitmap, wherein a temporal length associated with each duration of the plurality of durations is based at least in part on the quantity of bits.

Aspect 29: An apparatus for wireless communication at a UE, comprising a processor; memory coupled with the processor; and instructions stored in the memory and executable by the processor to cause the apparatus to perform a method of any of aspects 1 through 22.

Aspect 30: An apparatus for wireless communication at a UE, comprising at least one means for performing a method of any of aspects 1 through 22.

Aspect 31: A non-transitory computer-readable medium storing code for wireless communication at a UE, the code comprising instructions executable by a processor to perform a method of any of aspects 1 through 22.

Aspect 32: An apparatus for wireless communication at a network entity, comprising a processor; memory coupled with the processor; and instructions stored in the memory and executable by the processor to cause the apparatus to perform a method of any of aspects 23 through 28.

Aspect 33: An apparatus for wireless communication at a network entity, comprising at least one means for performing a method of any of aspects 23 through 28.

Aspect 34: A non-transitory computer-readable medium storing code for wireless communication at a network entity, the code comprising instructions executable by a processor to perform a method of any of aspects 23 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
receive, from a network entity, a plurality of indications of a plurality of uplink resource allocations, wherein the plurality of uplink resource allocations are associated with a plurality of configured grants that schedule a plurality of uplink transmission occasions for the UE across the plurality of uplink resource allocations on one or more component carriers;
transmit, to the network entity, uplink control information that indicates a set of uplink transmission occasions from the plurality of uplink transmission occasions during which the UE skips uplink transmissions; and
transmit, to the network entity, an uplink message in accordance with the plurality of configured grants and the uplink control information.

2. The apparatus of claim 1, wherein the instructions to transmit the uplink control information are executable by the processor to cause the apparatus to:
transmit the uplink control information during an uplink transmission occasion of the plurality of uplink transmission occasions and on a component carrier of the one or more component carriers, wherein the uplink transmission occasion is scheduled via a configured grant of the plurality of configured grants, and wherein the set of uplink transmission occasions occur subsequent to the uplink transmission occasion.

3. The apparatus of claim 2, wherein the set of uplink transmission occasions comprises one or more uplink transmission occasions that are scheduled via the configured grant.

4. The apparatus of claim 2, wherein the set of uplink transmission occasions comprises one or more uplink transmission occasions on the component carrier.

5. The apparatus of claim 2, wherein:
the set of uplink transmission occasions comprises a first one or more uplink transmission occasions that are scheduled via the configured grant and a second one or more other uplink transmission occasions that are scheduled via a second configured grant of the plurality of configured grants, and
the configured grant and the second configured grant are associated with different component carriers.

6. The apparatus of claim 2, wherein transmitting the uplink control information during the uplink transmission occasion scheduled via the configured grant indicates that the set of uplink transmission occasions is associated with at least the configured grant.

7. The apparatus of claim 2, wherein transmitting the uplink control information on the component carrier indicates that the set of uplink transmission occasions is associated with at least the component carrier.

8. The apparatus of claim 1, wherein the uplink control information comprises at least one configured grant identifier that indicates at least one configured grant of the plurality of configured grants that is associated with the set of uplink transmission occasions.

9. The apparatus of claim 1, wherein the uplink control information comprises at least one component carrier index that indicates at least one component carrier of the one or more component carriers that is associated with the set of uplink transmission occasions.

10. The apparatus of claim 1, wherein:
the uplink control information indicates a duration during which the UE skips uplink transmissions,
the set of uplink transmission occasions occur during the duration, and
the duration is associated with a timing offset.

11-16. (canceled)

17. The apparatus of claim 1, wherein:
the uplink control information comprises a bitmap that indicates a plurality of durations during which the UE skips uplink transmissions, and
the set of uplink transmission occasions occur across the plurality of durations.

18. (canceled)

19. The apparatus of claim 1, wherein the set of uplink transmission occasions occur during a duration associated with a default subcarrier spacing.

20. The apparatus of claim 1, wherein the set of uplink transmission occasions occur during a duration associated with a subcarrier spacing that is based at least in part on a component carrier used for transmission of the uplink control information.

21. The apparatus of claim 1, wherein an uplink transmission occasion of the set of uplink transmission occasions correspond to two uplink transmission occasions that are overlapping in time.

22. The apparatus of claim 1, wherein two or more uplink transmission occasion of the set of uplink transmission occasions are overlapping in time.

23. An apparatus for wireless communication at a network entity, comprising:
a processor;
memory coupled with the processor; and
instructions stored in the memory and executable by the processor to cause the apparatus to:
output a plurality of indications of a plurality of uplink resource allocations, wherein the plurality of uplink resource allocations are associated with a plurality of configured grants that schedule a plurality of uplink transmission occasions for a user equipment (UE) across the plurality of uplink resource allocations on one or more component carriers,
obtain uplink control information that indicates a set of uplink transmission occasions from the plurality of uplink transmission occasions during which the UE skips uplink transmissions; and
obtain an uplink message in accordance with the plurality of configured grants and the uplink control information.

24. The apparatus of claim 23, wherein the instructions to transmit the uplink control information are executable by the processor to cause the apparatus to:
obtain the uplink control information during an uplink transmission occasion of the plurality of uplink transmission occasions and on a component carrier of the one or more component carriers, wherein the uplink transmission occasion is scheduled via a configured grant of the plurality of configured grants, and wherein the set of uplink transmission occasions occur subsequent to the uplink transmission occasion.

25. The apparatus of claim 23, wherein the uplink control information comprises at least one configured grant identifier that indicates at least one configured grant of the plurality of configured grants that is associated with the set of uplink transmission occasions and indicates at least one component carrier index that indicates at least one component carrier of the one or more component carriers that is associated with the set of uplink transmission occasions.

26. The apparatus of claim 23, wherein:
the uplink control information indicates a duration during which the UE skips uplink transmissions,
the set of uplink transmission occasions occur during the duration, and
the duration is associated with a timing offset.

27-28. (canceled)

29. A method for wireless communication at a user equipment (UE), comprising:
receiving, from a network entity, a plurality of indications of a plurality of uplink resource allocations, wherein the plurality of uplink resource allocations are associated with a plurality of configured grants that schedule a plurality of uplink transmission occasions for the UE across the plurality of uplink resource allocations on one or more component carriers;
transmitting, to the network entity, uplink control information that indicates a set of uplink transmission occasions from the plurality of uplink transmission occasions during which the UE skips uplink transmissions; and
transmitting, to the network entity, an uplink message in accordance with the plurality of configured grants and the uplink control information.

30. (canceled)
